(19) United States
(12) Patent Application Publication
(10) Pub. No.: US 2025/0191472 A1
(43) Pub. Date: Jun. 12, 2025

(54) NAVIGATION SYSTEM, NAVIGATION METHOD, AND NAVIGATION PROGRAM

(71) Applicant: DENSO CORPORATION, Kariya-city (JP)

(72) Inventor: YOSHINORI TAKEUCHI, Kariya-city (JP)

(21) Appl. No.: 19/058,812

(22) Filed: Feb. 20, 2025

Related U.S. Application Data
(63) Continuation of application No. PCT/JP2023/024134, filed on Jun. 29, 2023.

(30) Foreign Application Priority Data
Aug. 24, 2022 (JP) 2022-133585

(51) Int. Cl. G08G 1/00; B60L 7/10; B60L 50/60; B60W 10/18; B60W 60/00

(52) U.S. Cl. CPC G08G 1/22; B60L 7/10; B60W 10/18; B60W 60/001; B60L 50/60; B60W 2530/16; B60W 2552/15; B60W 2555/20

(57) ABSTRACT

A navigation system, a navigation method, or a non-transitory computer-readable storage medium storing a navigation program for navigating a plurality of autonomous traveling devices that autonomously travel using power supplied from a battery, optimizes a platoon formation based on a gradient resistance that occurs on at least one of the plurality of autonomous traveling devices that are caused to travel in the platoon formation including a mutually connected formation and changes in future traveling on an uphill road, and navigates each autonomous traveling device to the optimized platoon formation.

### CROSS REFERENCE TO RELATED APPLICATIONS

The present application is a continuation application of International Patent Application No. PCT/JP2023/024134 filed on Jun. 29, 2023, which designated the U.S. and claims the benefit of priority from Japanese Patent Application No. 2022-133585 filed on Aug. 24, 2022. The entire disclosures of all of the above applications are incorporated herein by reference.

### TECHNICAL FIELD

The present disclosure relates to a navigation technology for navigating multiple autonomous traveling devices.

### BACKGROUND

A comparative navigation technology aims to minimize the total electric energy consumed by autonomous traveling devices that travel autonomously using power supplied from a battery by connecting the autonomous traveling devices.

### SUMMARY

A navigation system, a navigation method, or a non-transitory computer-readable storage medium storing a navigation program for navigating a plurality of autonomous traveling devices that autonomously travel using power supplied from a battery, optimizes a platoon formation based on a gradient resistance that occurs on at least one of the plurality of autonomous traveling devices that are caused to travel in the platoon formation including a mutually connected formation and changes in future traveling on an uphill road, and navigates each autonomous traveling device to the optimized platoon formation.

### BRIEF DESCRIPTION OF THE DRAWINGS

FIG. 1 is a schematic diagram showing a navigation system according to a first embodiment.

FIG. 2 is a configuration diagram showing an autonomous traveling device according to the first embodiment.

FIG. 3 is a block diagram showing the autonomous traveling device according to the first embodiment.

FIG. 4 is a block diagram showing the autonomous traveling device according to the first embodiment.

FIG. 5 is a configuration diagram showing an example of an adjustment unit according to the first embodiment.

FIG. 6 is a configuration diagram showing an example of an adjustment unit according to the first embodiment.

FIG. 7 is a block diagram showing the navigation system according to the first embodiment.

FIG. 8 is a functional block diagram showing a processing device of the navigation system according to the first embodiment.

FIG. 9 is a flowchart showing a navigation flow according to the first embodiment.

FIG. 10 is a schematic diagram showing traveling resistance according to the first embodiment.

FIG. 11 is a schematic diagram showing the traveling resistance according to the first embodiment.

FIG. 12 is a schematic diagram showing the traveling resistance according to the first embodiment.

FIG. 13 is a schematic diagram showing the traveling resistance according to the first embodiment.

FIG. 14 is a schematic diagram showing optimization of the platoon formation according to the first embodiment.

FIG. 15 is a schematic diagram showing the optimization of the platoon formation according to the first embodiment.

FIG. 16 is a schematic diagram showing optimization of the platoon formation according to the first embodiment.

FIG. 17 is a schematic diagram showing optimization of the platoon formation according to the first embodiment.

FIG. 18 is a schematic diagram showing optimization of the platoon formation according to the first embodiment.

FIG. 19 is a schematic diagram showing optimization of the platoon formation according to the first embodiment.

FIG. 20 is a schematic diagram showing an assumed wind direction in the first embodiment.

FIG. 21 is a schematic diagram showing an optimization limit of the platoon formation according to the first embodiment.

FIG. 22 is a schematic diagram showing the optimization limit of the platoon formation according to the first embodiment.

FIG. 23 is a schematic diagram showing a use case of the optimization of the platoon formation according to the first embodiment.

FIG. 24 is a schematic diagram showing the optimization of a platoon formation according to the first embodiment.

FIG. 25 is a schematic diagram showing optimization of the platoon formation according to the first embodiment.

FIG. 26 is a schematic diagram showing the optimization of the platoon formation according to the first embodiment.

FIG. 27 is a schematic diagram showing the optimization of the platoon formation according to the first embodiment.

FIG. 28 is a schematic diagram showing the optimization of the platoon formation according to the first embodiment.

FIG. 29 is a schematic diagram showing the optimization of the platoon formation according to the first embodiment.

FIG. 30 is a schematic diagram showing the optimization of the platoon formation according to the first embodiment.

FIG. 31 is a schematic diagram showing the optimization of the platoon formation according to the first embodiment.

FIG. 32 is a schematic diagram showing the optimization of the platoon formation according to the first embodiment.

FIG. 33 is a schematic diagram showing the optimization of the platoon formation according to the first embodiment.

FIG. 34 is a flowchart showing a navigation flow according to a second embodiment.

FIG. 35 is a schematic diagram showing the optimization of the platoon formation according to the second embodiment.

FIG. 36 is a schematic diagram showing the optimization of the platoon formation according to the second embodiment.

FIG. 37 is a flowchart showing a navigation flow according to a third embodiment.

### DETAILED DESCRIPTION

In the comparative navigation technology, the traveling order of electrically connected autonomous traveling devices is adjusted so as to minimize the total electric energy. However, it has been found that the total electric energy consumption is determined by other traveling factors rather than the traveling order.

One example of the present disclosure provides a navigation system that reduces consumption of electric energy. Another example of the present disclosure provides a navigation method that reduces consumption of electric energy. Further, another example of the present disclosure provides a navigation program that reduces consumption of electric energy.

According to a first example embodiment of the present disclosure, a navigation system navigates multiple autonomous traveling devices that autonomously travel using power supplied from a battery, and the system includes: a processor configured to: optimize a platoon formation based on a gradient resistance that occurs on at least one of the multiple autonomous traveling devices that are caused to travel in the platoon formation including a mutually connected formation and changes in future traveling on an uphill road; and navigate each autonomous traveling device to the optimized platoon formation.

According to a second example embodiment of the present disclosure, a navigation method is executed by a processor for navigating multiple autonomous traveling devices that autonomously travel using power supplied from a battery, and the method includes: optimizing a platoon formation based on a gradient resistance that occurs on at least one of the multiple autonomous traveling devices that are caused to travel in the platoon formation including a mutually connected formation and changes in future traveling on an uphill road; and navigating each autonomous traveling device to the optimized platoon formation.

According to a third example embodiment of the present disclosure, anon-transitory computer-readable storage medium stores a navigation program including instructions executed by a processor for navigating a plurality of autonomous traveling devices that autonomously travel using power supplied from a battery, the processor being configured to: optimize a platoon formation based on a gradient resistance that occurs on at least one of the multiple autonomous traveling devices that are caused to travel in the platoon formation including a mutually connected formation and changes in future traveling on an uphill road; and navigate each autonomous traveling device to the optimized platoon formation.

According to these first to third example embodiments, the platoon formation, including the mutually connected formation, is optimized based on the changing gradient resistance of at least one of the autonomous traveling devices in future traveling on an uphill road. According to this, each autonomous traveling device can be navigated by providing the mutually connected formation that can reduce power consumption from the perspective of gradient resistance, which affects the total electric energy. Therefore, it is possible to reduce the total consumption of electric energy.

The following will describe embodiments of the present disclosure with reference to the drawings. It should be noted that the same reference numerals are assigned to corresponding components in the respective embodiments, and overlapping descriptions may be omitted. When only a part of the configuration is described in the respective embodiments, the configuration of the other embodiments described before may be applied to other parts of the configuration. Further, not only the combinations of the configurations explicitly shown in the description of the respective embodiments, but also the configurations of the plurality of embodiments can be partially combined together even if the configurations are not explicitly shown if there is no problem in the combination in particular.

### First Embodiment

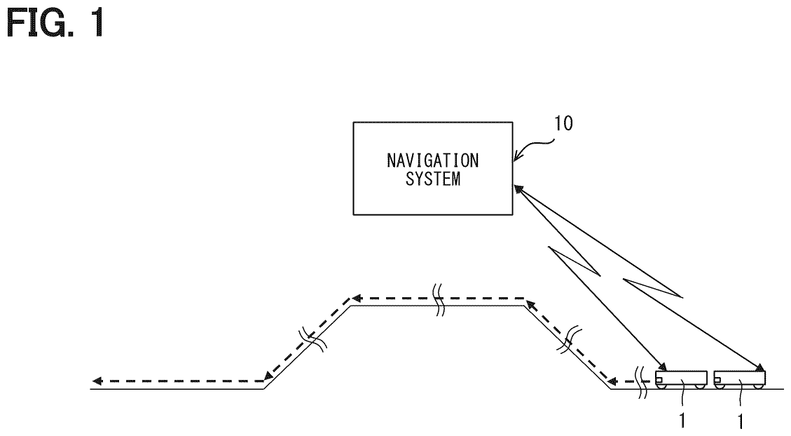

A navigation system 10 according to the first embodiment shown in FIG. 1 navigates multiple autonomous traveling devices 1 that travel autonomously. Each autonomous traveling device 1 that is the target of navigation by the navigation system 10 can autonomously travel in any direction, forward, rearward, leftward or rightward, according to the navigation. Here, the autonomous traveling device 1 may be a delivery vehicle that autonomously travels on a road and transports packages to the delivery destination. The autonomous traveling device 1 may be a logistics vehicle that autonomously travels through a warehouse to transport the package. The autonomous traveling device 1 may be a disaster support robot that autonomously travels around a disaster area to transport supplies or collect information. The autonomous traveling device 1 may be of a category other than those described above.

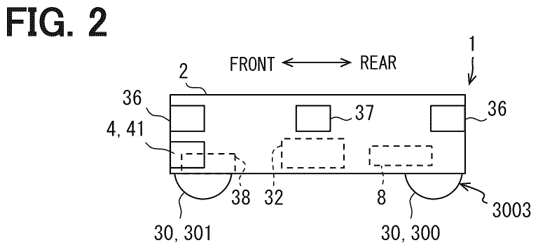

As shown in FIGS. 2 to 4, each autonomous traveling device 1 includes a body 2, a drive system 3, a sensor system 4, a communication system 5, a map database 6, an information presentation system 7, and a control system 8. However, the autonomous traveling devices 1 may have completely or substantially the same configuration, or may have different configurations as long as they include the functions of the components 2 to 8.

The body 2 has a hollow shape, which is made of metal, for example. The body 2 holds other components of the autonomous traveling device 1 inside or across the body 2. The body 2 forms the external shape of the autonomous traveling device 1 in cooperation with wheels 30 (described later) in the drive system 3.

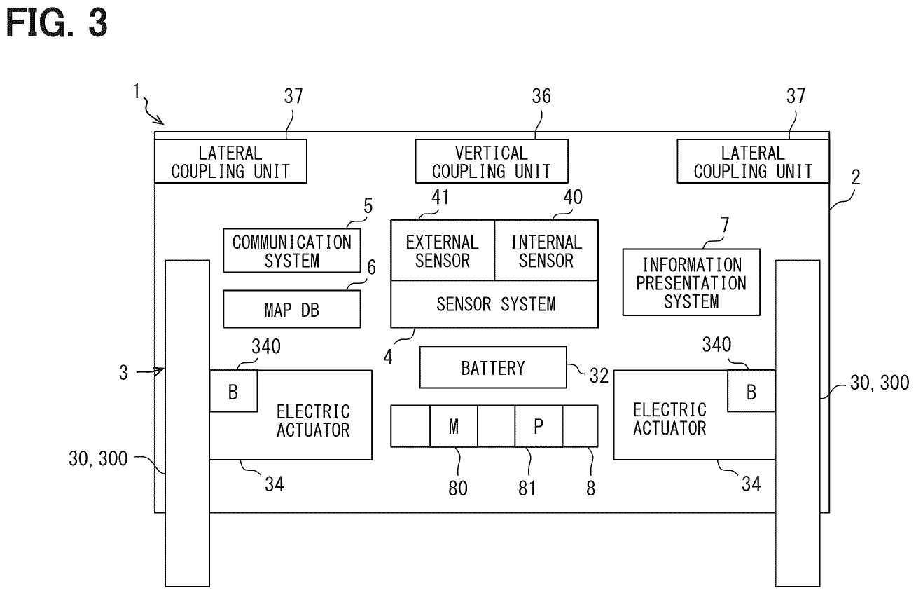

The drive system 3 includes wheels 30, a battery 32, an electric actuator 34, coupling units 36 and 37, and an adjustment unit 38. The multiple wheels 30 are configured to rotate independently of each other. As shown in FIGS. 2 and 3, the wheels 30 includes drive wheels 300 that are provided respectively to the left portion and the right portion of the body 2, and drive wheels 300 are independently driven by the electric actuators 34 provided respectively for the drive wheels 300. In particular, in the present embodiment, the rotation speed difference (that is, the rotation speed difference per unit time) between the drive wheels 300 determines whether the autonomous traveling device 1 drives straight or turns.

Specifically, the autonomous traveling device 1 travels straight when the rotation speed difference between the two right and left drive wheels 300 is zero or substantially zero. On the other hand, the autonomous traveling device 1 turns when the rotation speed difference between the right and left drive wheels 300 increases. The greater the rotation speed difference, the less the turning radius of the autonomous traveling device 1 is. Here, the turning radius means the distance between the vertical center line of the body 2 and the center of the turning in a planar view. The turning of the autonomous traveling device 1 is a point turning when the turning radius is substantially zero.

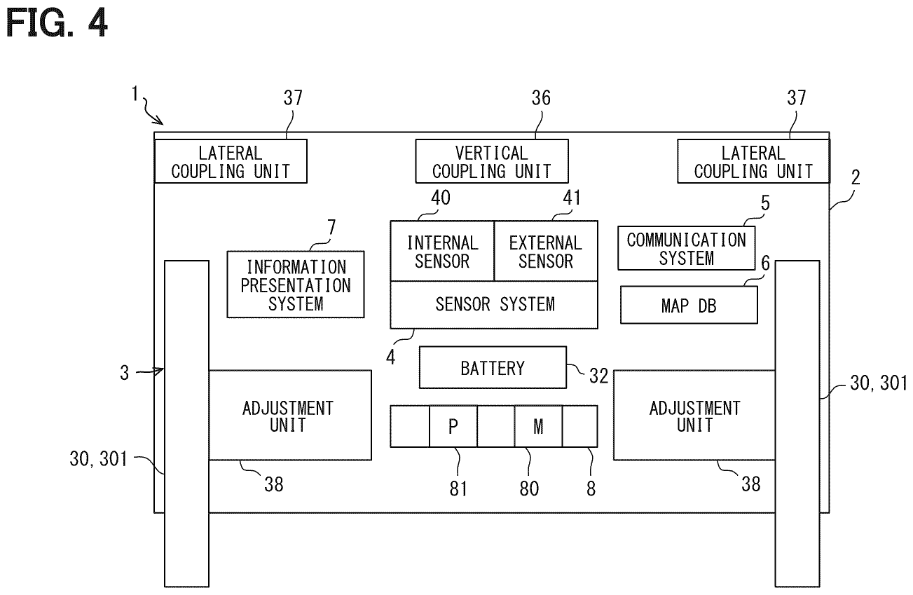

As shown in FIGS. 2 and 4, the multiple wheels 30 include at least one driven wheel 301 that rotates following the drive wheel 300. In this embodiment, two driven wheels 301 are located in front of each of the drive wheels 300, that is, on the left and right.

As shown in FIGS. 2 to 4, the battery 32 mainly includes a storage battery such as a lithium ion battery, for example. The battery 32 stores electric power by charging from an external device and supplies the electric power to electric components in the autonomous traveling device 1 by discharging. The battery 32 may collect and store regenerative electric power generated in an electric actuator 34 capable of regenerative braking of the drive wheels 300. The battery 32 is connected to the electric actuator 34, the sensor system 4, the communication system 5, the map database 6, the information presentation system 7, and the control system 8 via, for example, a wire harness so as to supply power thereto.

Each of the pair of electric actuators 34 shown in FIGS. 2 and 3 mainly includes an electric motor and a motor drive circuit. Each electric actuator 34 independently drives and rotates the corresponding drive wheel 300 using power supplied from the battery 32. Thereby, the autonomous traveling device 1 is caused to travel autonomously. Each electric actuator 34 has a regenerative function of applying regenerative braking to the corresponding drive wheel 300 to generate regenerative power. As shown in FIG. 3, each electric actuator 34 is provided with an electric brake unit 340 that mechanically brakes the corresponding drive wheel 300. Each electric actuator 34 may be provided with an electric lock unit that mechanically locks the corresponding drive wheel 300.

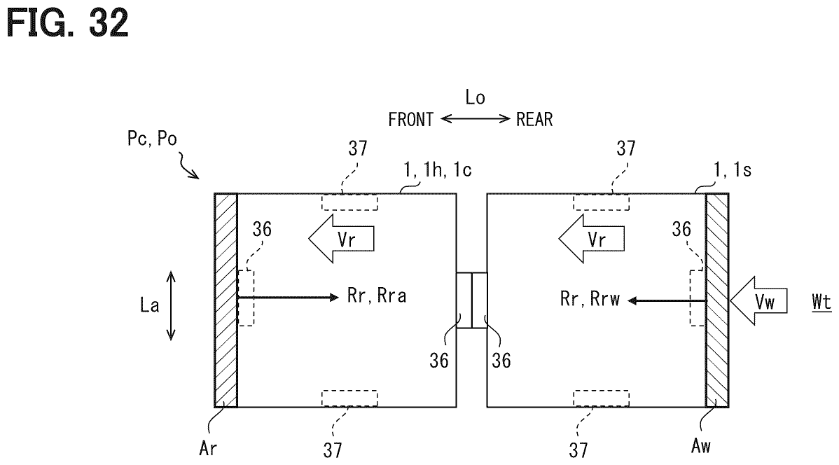

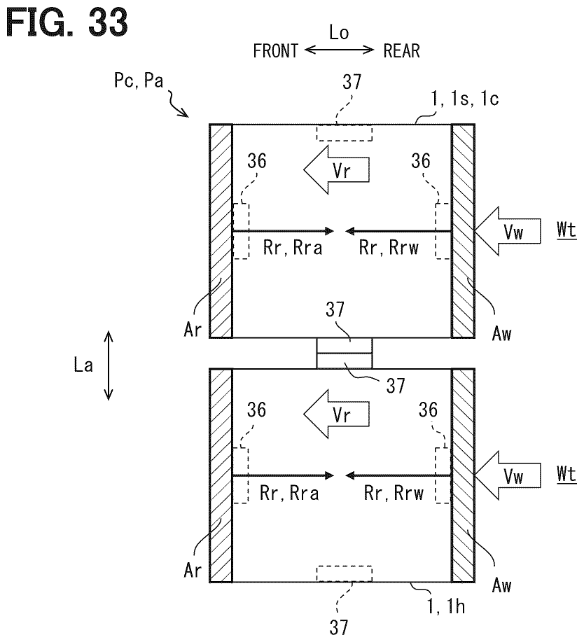

As shown in FIGS. 2 to 4, vertical coupling units 36 are held at the front and rear of the body 2 to connect the autonomous traveling devices 1 in a platoon formation in which the devices are arranged in a vertical direction Lo of a traveling road (see FIGS. 32 and 33 described later). The lateral coupling units 37 are held at the left and right of the body 2 to couple devices 1h, 1s arranged side by side in a lateral direction La of the traveling road (see FIGS. 32 and 33 described later). Each of these coupling units 36, 37 mainly includes, for example, an electric coupler that can electrically control the mechanical connection and release of complementary units.

As shown in FIGS. 2 and 4, the adjustment units 38 are held on the left and right sides of the body 2 in order to adjust the respective driven wheels 301 of the wheels 30 to switch between a contact state with and a separation state from the road. Each adjustment unit 38 electrically controls the mechanical attitude of the corresponding driven wheel 301 relative to the body 2. Thus, the mechanism is mainly configured with, for example, an electric attitude variable mechanism that can adjust the corresponding driven wheel 301 to switch between the contact state with and the separation state from the travel road.

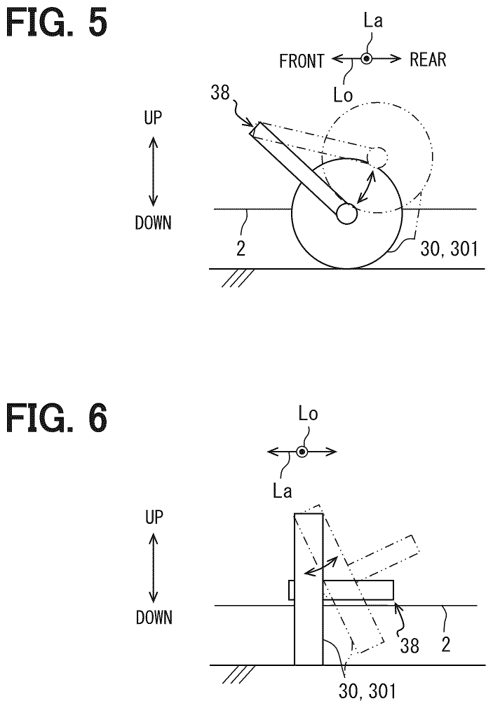

Here, as shown in FIG. 5, each adjustment unit 38 may adjust the corresponding driven wheel 301 to switch between the contact state with and the separation state from the traveling road by swinging the corresponding driven wheel 301 around a horizontal line in the lateral direction La of the body 2. As shown in FIG. 6, each adjustment unit 38 may adjust the corresponding driven wheel 301 to switch between the contact state with and the separation state from the traveling road by swinging the corresponding driven wheel 301 around a horizontal line in the vertical direction Lo of the body 2.

The sensor system 4 shown in FIGS. 2 to 4 acquires sensing information that can be used for navigation and autonomous traveling of the autonomous traveling device 1 by sensing the internal and external environments of the autonomous traveling device 1. Specifically, the sensor system 4 has at least one internal sensor 40 and at least one external sensor 41. The internal sensor 40 acquires internal environment information as sensing information from the internal environment of the autonomous traveling device 1. The internal sensor 40 may be a physical quantity detection type of acquiring the internal information by detecting a specific physical quantity of motion inside the autonomous traveling device 1. The internal sensor 40 of the physical quantity detection type is at least one of a driving speed sensor, an acceleration sensor, an yaw rate sensor, and the like.

The external sensor 41 acquires external environment information as sensing information from the external environment that is the peripheral environment of the autonomous traveling device 1. The external sensor 41 may be of a object detection type, which acquires external information by detecting an object existing in the external environment of the autonomous traveling device 1. The external sensor 41 of the object detection type is at least one of a camera, a Light Detection and Ranging/Laser Imaging Detection and Ranging (LiDAR), a radar, sonar, and the like, for example. The external sensor 41 may be a positioning type sensor that acquires external environment information by receiving a positioning signal from an artificial satellite of a global navigation satellite system (GNSS) present outside the autonomous traveling device 1. The external sensor 41 of a positioning type is, for example, a GNSS receiver or the like.

The communication system 5 shown in FIGS. 3 and 4 transmits and receives communication information related to the autonomous traveling of the autonomous traveling device 1 via wireless communication between the autonomous traveling device 1 and the external environment. The communication system 5 may be a V2X type communication system that exchanges communication information with a Vehicle to Everything (i.e., V2X) system located in the external environment of the autonomous traveling device 1. The communication system 5 of the V2X type may be at least one of a dedicated short range communications (i.e., DSRC) communication device, a cellular V2X (i.e., C-V2X) communication device, or the like, for example. The communication system 5 may be a terminal communication type communication system that exchanges communication information with a mobile terminal existing in the external environment of the autonomous traveling device 1. For example, the communication system 5 having the terminal communication type may be at least one of a Bluetooth (registered trademark) device, a Wi-Fi (registered trademark) device, an infrared communication device, or the like.

The map database 6 acquires map information that can be used for the navigation and the autonomous traveling of the autonomous traveling device 1 from the navigation system 10 via the communication system 5 and stores it. The map database 6 mainly includes at least one non-transitory tangible storage medium capable of storing map information, such as a semiconductor memory, a magnetic medium, and an optical medium, for example.

The map information stored in the map database 6 is converted into two-dimensional or three-dimensional data as information indicating the traveling environment of the autonomous traveling device 1. The map information may include road information indicating at least one of road position, road shape, road surface condition, or the like, for example. The map information may include marking information, which indicates at least one of traffic sign attached to a road, lane mark position, or lane mark shape, for example. The map information may include, for example, structure information indicating at least one of positions or shapes of a building and a traffic light along a road.

The information presentation system 7 presents notification information directed to the external environment of the autonomous traveling device 1 regarding navigation and autonomous traveling of the autonomous traveling device 1. The information presentation system 7 may present notification information by stimulating the vision of a human being in the external environment of the autonomous traveling device 1. The visual stimulation type information presentation system 7 is at least one of a monitor unit or a light emitting unit, for example. The information presentation system 7 may present notification information by stimulating the hearing sense of a human being in the external environment of the autonomous traveling device 1. The auditory stimulation type information presentation system 7 is, for example, at least one of a speaker, a buzzer, a vibration unit, and the like.

The control system 8 shown in FIGS. 2 to 4 mainly includes at least one dedicated computer. The dedicated computer constituting the control system 8 has at least one memory 80 and at least one processor 81. The memory 80 is at least one type of non-transitory tangible storage medium, such as a semiconductor memory, a magnetic medium, and an optical medium, for storing, in non-transitory manner, computer readable programs and data. The processor 81 includes, as a core, at least one type of, for example, a CPU (Central Processing Unit), a GPU (Graphics Processing Unit), an RISC (Reduced Instruction Set Computer)-CPU, and so on.

The control system 8 is connected to the battery 32, the electric actuator 34, the coupling units 36, 37, the adjustment unit 38, the sensor system 4, the communication system 5, the map database 6, and the information presentation system 7 via at least one of, for example, a LAN (Local Area Network) line, a wire harness, or an internal bus. The control system 8 controls each connected object so that the autonomous traveling device 1 implements autonomous traveling in accordance with navigation from the navigation system 10 by executing multiple instructions of a control program stored in the memory 80 using the processor 81.

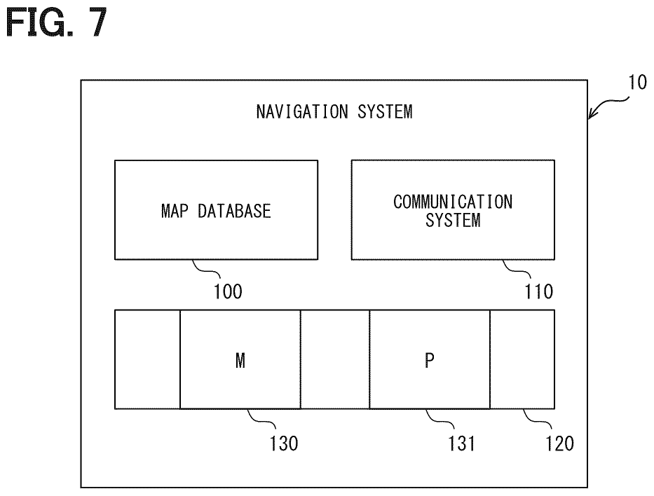

The navigation system 10 shown in FIG. 1 is constructed in a remote center that navigates multiple autonomous traveling devices 1 through remote management. As shown in FIG. 7, the navigation system 10 includes a map database 100, a communication system 110, and a processing device 120, and is at least one of a cloud server or an edge server, for example.

The map database 100 stores map information used to navigate each autonomous traveling device 1, and updates the map information to the latest information as needed. The configuration of the map database 100 in the autonomous traveling device 1 is similar to the configuration of the map database 6 in the navigation system 10, but stores, as compared with the later, a larger amount of map information capable of covering the autonomous traveling areas (hereinafter referred to as navigation areas) of all autonomous traveling devices 1 that are under navigation.

The communication system 110 mainly includes communication equipment that serves as at least a part of a V2X system capable of communicating with the communication system 5 of each autonomous traveling device 1. The processing device 120 is connected to the map database 100 and the communication system 110 via at least one of a wired communication line or a wireless communication line. Regarding the navigation area of each autonomous traveling device 1, in addition to the map information in the map database 100, for example, at least one type of environmental information, such as traffic information, road information, weather information, or scene information, is obtained through the communication system 110 and provided to the processing device 120 at any time. Regarding the future traveling of each autonomous traveling device 1, target traveling information is obtained through the communication system 110, includes, for example, destination information, traveling route information, and schedule information, and is provided to the processing device 120 at any time or planned by the processing device 120.

The processing device 120 includes at least one dedicated computer. The dedicated computer constituting the processing device 120 has at least one memory 130 and at least one processor 131. The configuration of the memory 130 and the processor 131 in the processing device 120 is similar to the configuration of the memory 80 and the processor 81 of the control system 8 in the autonomous traveling device 1, but has a more sophisticated configuration than the latter memory 80 and the latter processor 81.

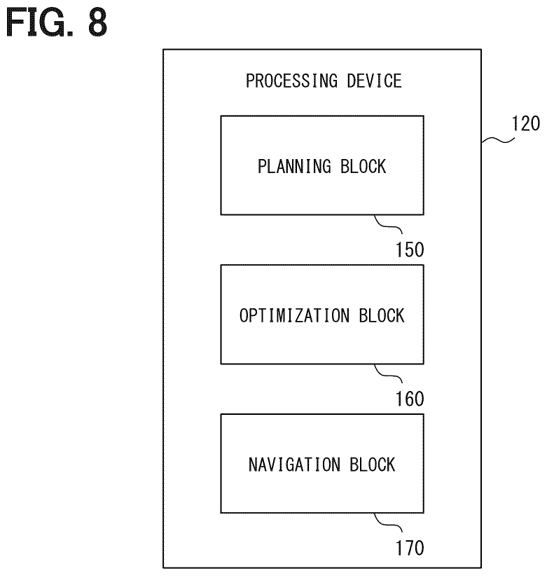

In the navigation system 10, the processing device 120 executes instructions of a processing program stored in the memory 130 by means of the processor 131. As a result, the processing device 120 executes the navigation process to navigate multiple autonomous traveling devices 1 (two autonomous traveling devices in a pair in the present embodiment) that travel autonomously using power supplied from the battery 32 into a platoon formation. In such a processing device 120, multiple functional blocks for executing the navigation process are constructed. The functional blocks thus constructed include a planning block 150, an optimization block 160, and a navigation block 170, as shown in FIG. 8.

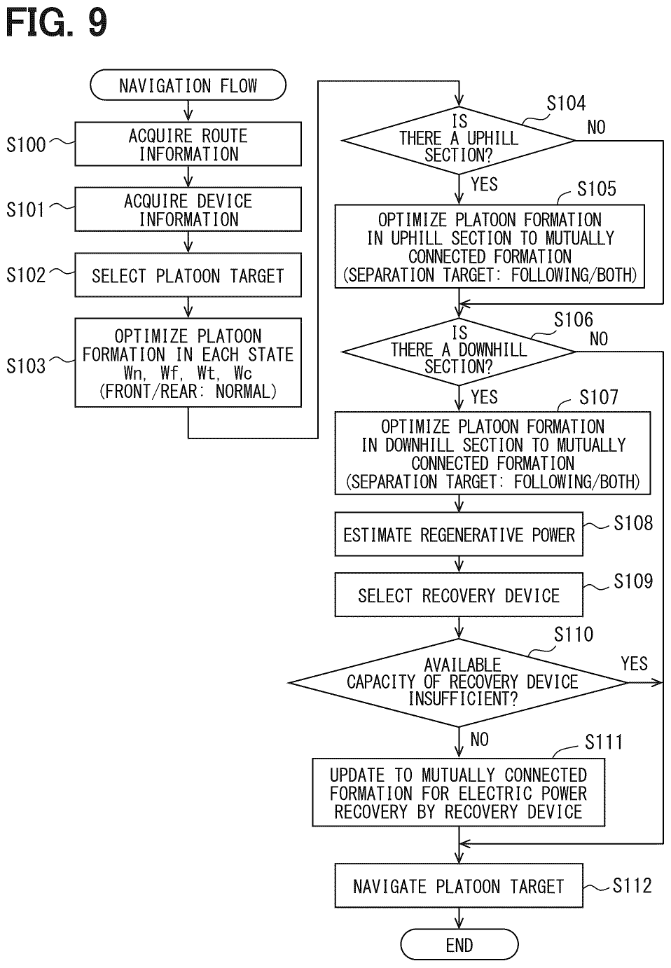

A navigation method in which the processing device 120 navigates the autonomous traveling devices 1 traveling in a platoon formation (hereinafter also referred to as platoon traveling) through the cooperation of these blocks 150, 160, and 170 is executed according to the navigation flow shown in FIG. 9. This navigation flow is executed when a request for platooning by a pair of autonomous traveling devices 1 occurs while the navigation system 10 is activated. Moreover, each “S” in this navigation flow represents multiple processes executed by multiple instructions contained in the navigation program.

In S100, the planning block 150 acquires route information as information regarding the traveling route along which each autonomous traveling device 1 will travel in formation. The route information may include, for example, destination information and waypoint information that each autonomous traveling device 1 is going to reach by platooning. The route information may include path information that causes each autonomous traveling device 1 to travel in a platooning manner in accordance with destination information or route information. The route information may include road information representing, for example, a planar shape of the road, a gradient angle of the road, and a road surface friction coefficient of the road for each traveling point or each traveling section according to path information. The route information may include environmental information indicating, for example, wind direction, wind speed, and the like for each travel point along path information.

In S101, the planning block 150 acquires device information from the autonomous traveling devices 1 that are candidates for selection in order to select autonomous traveling devices 1 that are targets for platooning based on route information. The selection candidates may be set to at least two autonomous traveling devices 1 that are not currently executing a task and are located at traveling positions where they can participate in platoon traveling according to the path information in the route information. The device information may include battery information indicating, for example, the charging state and degradation state as the state of the battery 32 in the autonomous traveling device 1 that is a selection candidate. The device information may include actuator information indicating the state of each electric actuator 34 in the autonomous traveling device 1 that is a selection candidate, such as the deterioration state and regenerative characteristics due to braking. The device information may include shape information that represents the external shape of the autonomous traveling device 1 that is a selection candidate. The device information may include motion information that indicates, for example, the traveling speed, as a motion physical quantity of the autonomous traveling device 1 that is a selection candidate.

Next, in S102, the planning block 150 selects a pair of autonomous traveling devices 1 that are the platoon target based on the route information and on device information acquired from each of the autonomous traveling devices 1 that are candidates for selection. At this time, when there are three or more selection candidates, each autonomous traveling device 1 that is the platoon target may be selected in order of the selection candidate with the least deterioration of the battery 32. When there are three or more selection candidates, each autonomous traveling device 1 that is the platoon target may be selected in order of the selection candidate with the least deterioration of the electric actuator 34. When there are three or more selection candidates, each autonomous traveling device 1 that is the platoon target may be selected in order from the candidate with the exterior shape that provides the least air resistance when traveling alone.

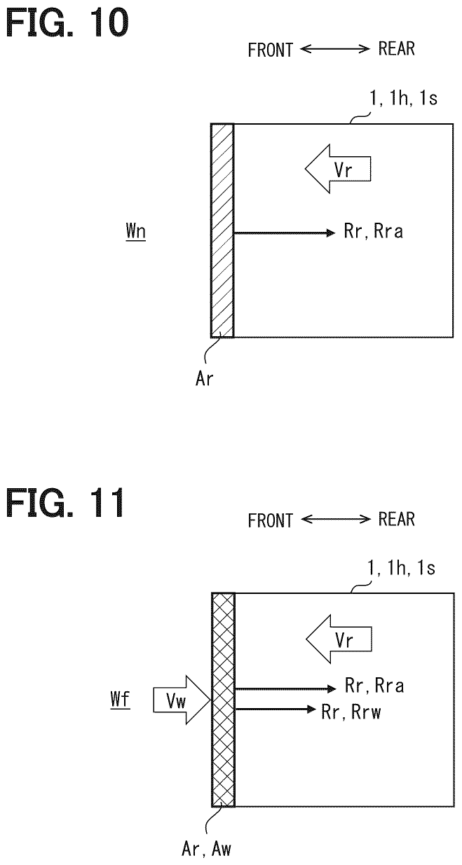

Next, in S103, the optimization block 160 optimizes the formation of the platoon based on the traveling resistance Rr that is going to change in future traveling of at least one of the autonomous traveling devices 1 that is going to be caused to travel in the platoon formation. Specifically, the optimization of the platoon formation is performed based on the air resistance Rra and wind resistance Rrw shown in FIGS. 10 to 13 as the traveling resistance Rr monitored for at least one autonomous traveling device 1.

Here, the air resistance Rra is the traveling resistance Rr that depends on the traveling speed Vr generated in the autonomous traveling device 1. The air resistance Rra may be calculated as a resistance value proportional to each of the traveling direction projected area Ar of the autonomous traveling device 1 and the traveling speed Vr, for example, as shown in FIGS. 10 to 13. Here, the traveling direction projection area Ar is defined as the projection area of the external shape of the autonomous traveling device 1, the shape being projected from the rear to the front in the traveling direction. The traveling direction projection area Ar is recognized based on the shape information among the device information acquired in S101. The traveling speed Vr is recognized based on the motion information from among the device information acquired in S101.

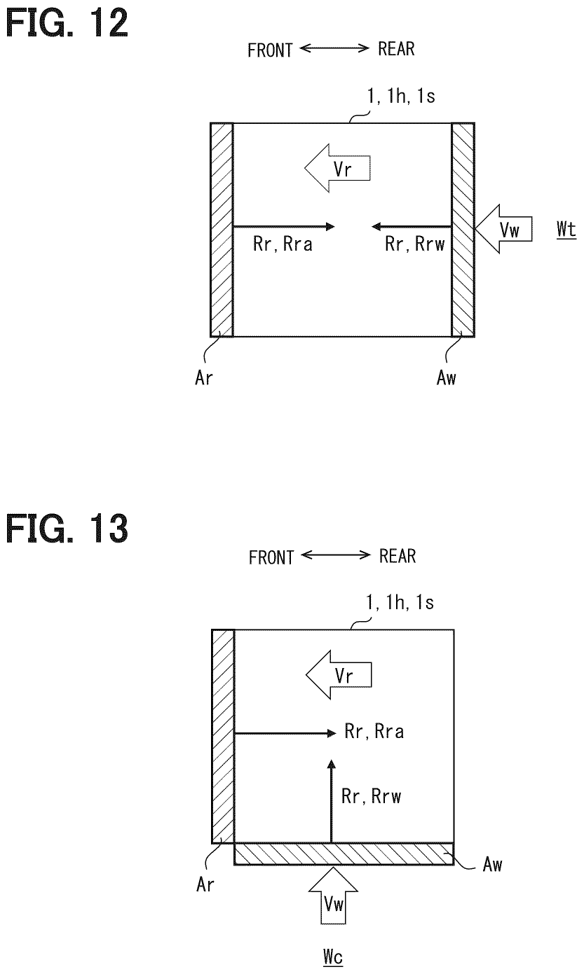

On the other hand, the wind resistance Rrw is the traveling resistance Rr that depends on the wind speed Vw acting on the autonomous traveling device 1. The wind resistance Rrw may be calculated as a resistance value proportional to each of the wind direction projection area Aw of the autonomous traveling device 1 and the wind speed Vw, for example, as shown in FIGS. 10 to 13. Here, the wind direction projection area Aw is defined as the projection area of the external shape of the autonomous traveling device 1, the shape being projected in the direction opposite to the wind direction. In particular, the wind resistance Rrw in a tailwind state Wt (described in detail later) in FIG. 12 that is opposite to the traveling direction is defined as a negative resistance that serves as a propulsive force for the autonomous traveling device 1. The wind direction projection area Aw is recognized based on the shape information among the device information acquired in S101. The wind direction and wind speed Vw are recognized based on the environmental information included in the route information acquired in S100.

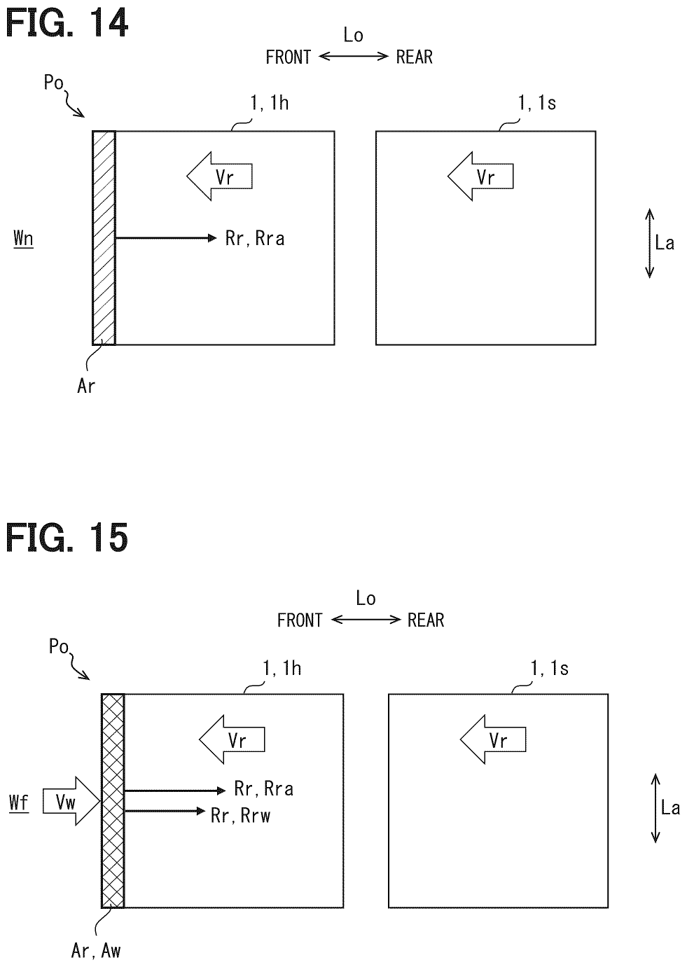

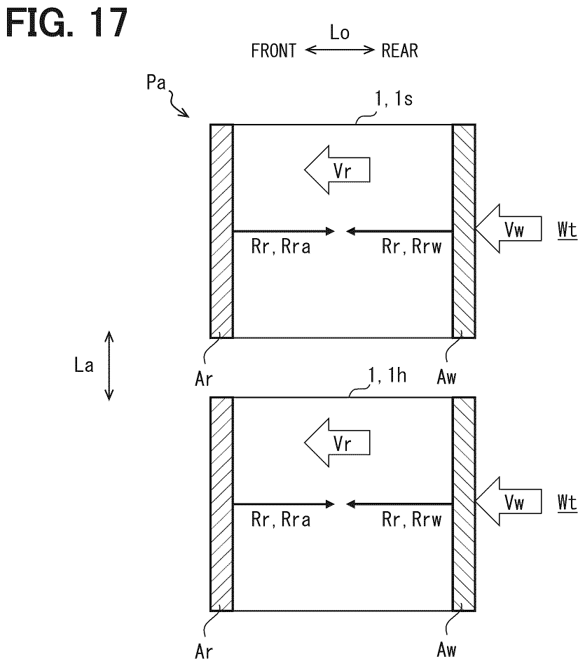

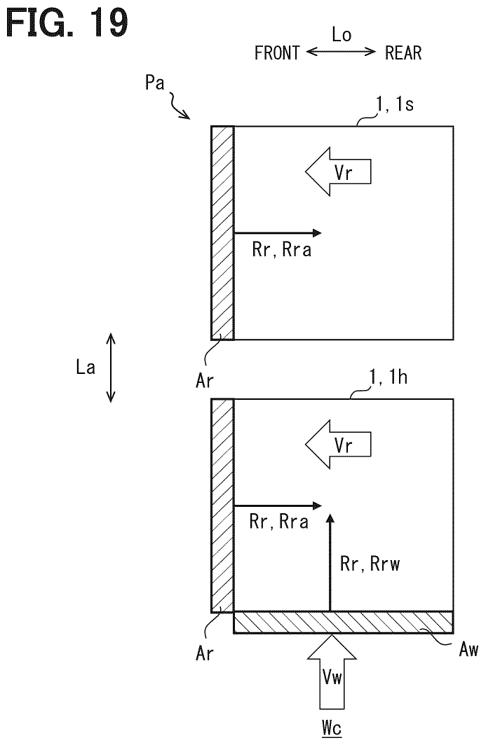

In the optimization in S103, one of platoon formations is selected for each traveling point or traveling section. The formation includes: a vertical formation Po in which the autonomous traveling devices 1 are lined up in the vertical direction Lo of the traveling road as shown in FIGS. 14 to 16 and 18; and a parallel formation Pa in which the autonomous traveling devices 1 are lined up in the lateral direction La of the traveling road as shown in FIGS. 17 and 19. In other words, the assumed platoon formation that can be selectively optimized as the future traveling progresses includes a vertical formation Po, in which each autonomous traveling device 1 is arranged in the vertical direction Lo, and a parallel formation Pa, in which each autonomous traveling device 1 is arranged in the lateral direction La.

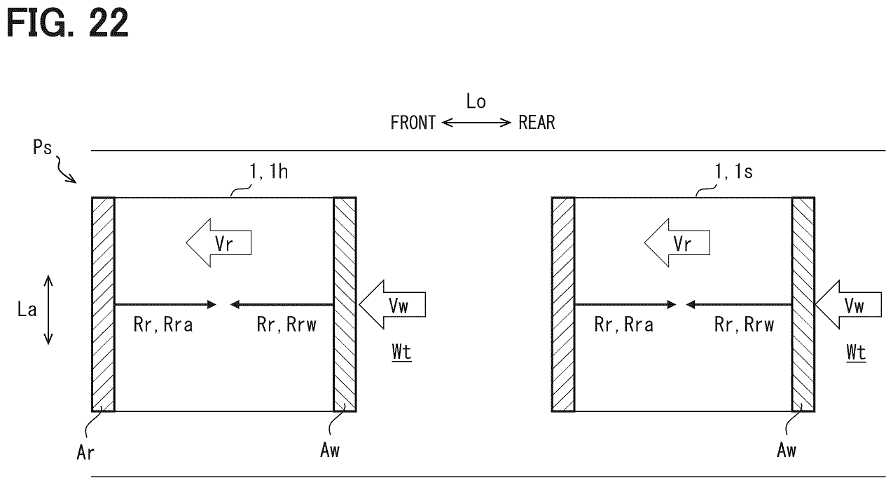

In the optimization in S103, the autonomous traveling device 1 that is going to travel in the lead in the assumption of the vertical formation Po is defined as a lead device 1h, and the autonomous traveling device 1 that is going to travel following the lead device 1h in the assumption of the vertical formation Po is defined as a following device 1s. Therefore, the optimization block 160 in S103 compares the traveling resistances Rr that are assumed to act in each autonomous traveling device 1 that is the platoon target in a solo traveling formation Ps (see FIG. 22 described below) in which the distance in the vertical direction Lo is separated from each other by a set distance or more. As a result, the optimization block 160 assigns each autonomous traveling devices 1 that is the platoon target to the leading device 1h and the following device 1s based on the comparison results of the traveling resistance Rr of each autonomous traveling device 1. In this case, for example, the autonomous traveling device 1 having the smaller air resistance Rra among the traveling resistances Rr may be assigned to the leading device 1h.

Furthermore, the optimization block 160 in S103 optimizes the platoon formation in accordance with the correlation between the air resistance Rra and the wind resistance Rrw, which is assumed as the traveling resistance Rr in the independent traveling formation Ps for the following device 1s. At this time, the leading device 1h, which is made to travel ahead of the following device 1s focusing on the air resistance Rra and the wind resistance Rrw, may be set to have a smaller air resistance Rra in accordance with the external shape based on the shape information among the device information acquired by S101. The leading device 1h traveling ahead may be set to the one with the largest free charge capacity according to the charge state of the battery 32 based on the battery information among the device information acquired in S101. In addition, in S103 of the first embodiment, the front-to-rear relationship of the traveling direction along the vertical direction Lo of the traveling road in each device 1h, 1s is maintained to the same normal relationship as in the case of the solo traveling formation Ps, regardless of the type of platoon formation to be optimized.

With regard to the following device 1s, in the case where air resistance Rra acts on wind resistance Rrw which is essentially zero in a windless condition Wn of FIG. 10, in S103, the optimization block 160 optimizes the platoon formation to the vertical formation Po shown in FIG. 14, regardless of the magnitude relationship between the wind resistance Rrw and the air resistance Rra. Here, the windless state Wn may be defined as a state in which the wind speed Vw based on the environmental information in the route information acquired in S100 is zero or less than a wind determination threshold value that is zero or can be assumed to be zero (for example, 1.4 m/s). As a result, in the case of the windless state Wn where the wind resistance Rrw is zero or can be assumed to be zero, the vertical formation Po is selected as the platoon formation. Thereby, the arrangement direction of each device 1h, 1s is optimized to the vertical direction Lo.

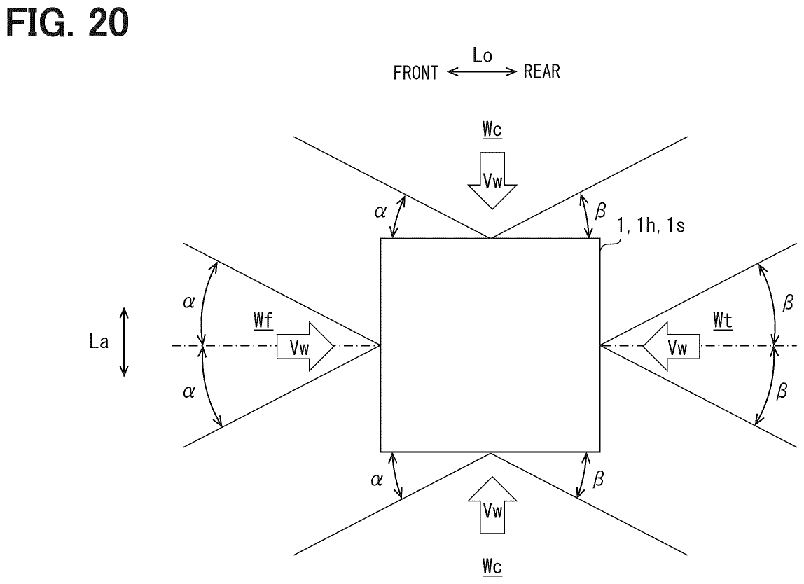

With regard to the following device 1s, in the case where air resistance Rra acts together with wind resistance Rrw in the headwind condition Wf of FIG. 11, in S103 the optimization block 160 optimizes the platoon formation to the vertical formation Po shown in FIG. 15, regardless of the magnitude relationship between the wind resistance Rrw and the air resistance Rra. Here, the headwind condition Wf may be defined as a state in which the wind speed Vw based on the environmental information acquired by S100 exceeds zero or exceeds the wind determination threshold, and the wind direction based on the same environmental information is within a headwind determination angle α (for example, 10 degrees) in the left and right directions based on the traveling direction, as shown in FIG. 20. In other words, the headwind state Wf may be considered as a state in which the following device 1s receives the wind having a vertical direction Lo component or a wind that can be regarded as having the vertical component and comes from the front. As a result, in the case of headwind state Wf in which the acting direction of the wind resistance Rrw is the opposite direction to the traveling direction or can be assumed to be the opposite direction, the vertical formation Po is selected as the platoon formation. As a result, it can be said that the arrangement direction of the devices 1h and 1s is optimized in the vertical direction Lo.

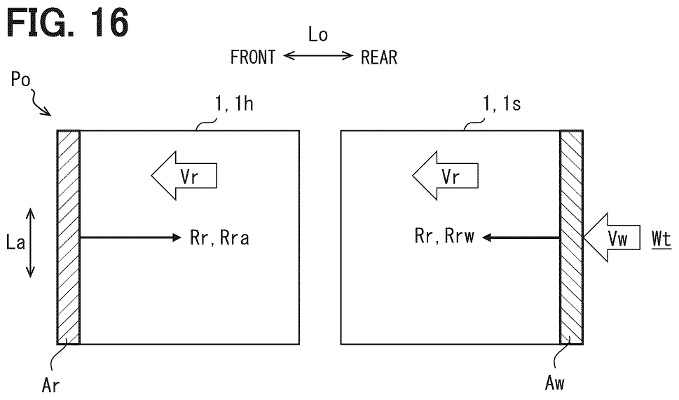

With respect to the following device 1s, in the case where the air resistance Rra is greater than the absolute value of the wind resistance Rrw acting in the tailwind state Wt of FIG. 12, the optimization block 160 in S103 optimizes the platoon formation to the vertical formation Po shown in FIG. 16. Here, the tailwind state Wt is defined as a state in which the wind speed Vw based on the environmental information acquired by S100 exceeds zero or exceeds the wind determination threshold, and the wind direction based on the same environmental information is within the tailwind determination angle β (for example, 10 degrees) on the left and right directions based on the direction opposite to the traveling direction, as shown in FIG. 20. In other words, the tailwind state Wt may be assumed to be a state in which the following device 1s receives the wind that is the vertical direction Lo component or a wind that can be regarded as the component. As a result, in the tailwind state Wt where the direction of action of wind resistance Rrw, which has an absolute value smaller than that of air resistance Rra, is the opposite direction to the direction of travel or can be assumed to be the opposite direction, the vertical formation Po is selected as the platoon formation, and the arrangement direction of each device 1h, 1s is optimized to the vertical direction Lo.

With respect to the following device 1s, in the case where the air resistance Rra is smaller than the absolute value of the wind resistance Rrw acting in the tailwind state Wt, the optimization block 160 optimizes the platoon formation to the parallel formation Pa shown in FIG. 17 in S103. Here, the tailwind state Wt may be defined in the same manner as described above. As a result, in the tailwind state Wt where the direction of action of wind resistance Rrw, which has an absolute value larger than that of air resistance Rra, is the opposite direction to the traveling direction or can be assumed to be the opposite direction, the parallel formation Pa is selected as the platoon formation, and the arrangement direction of each device 1h, 1s is optimized to the lateral direction La.

When the air resistance Rra is substantially equal to the wind resistance Rrw in the tailwind state Wt, the platoon formation may be optimized to the vertical formation Po similar to that shown in FIG. 16. The platoon formation when the air resistance Rra is substantially equal to the wind resistance Rrw in the tailwind state Wt may be optimized to the parallel formation Pa similar to that shown in FIG. 17.

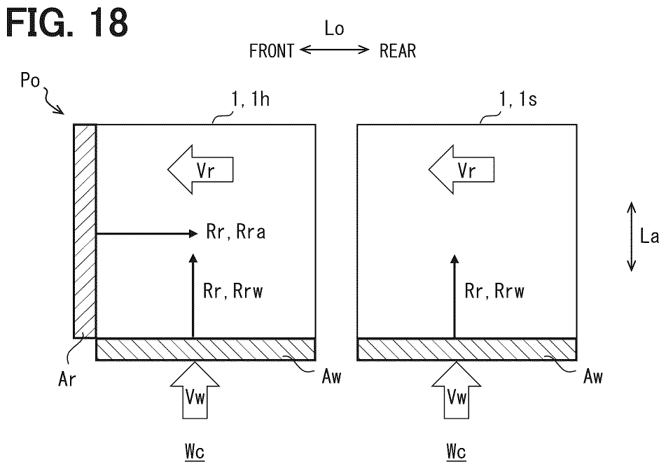

With respect to the following device 1s, in the case where the air resistance Rra is greater than the wind resistance Rrw acting in a crosswind state Wc of FIG. 13, the optimization block 160 in S103 optimizes the platoon formation to the vertical formation Po shown in FIG. 18. Here, the crosswind state Wc can be defined as a state in which the wind speed Vw based on the environmental information acquired by S100 exceeds zero or exceeds the wind determination threshold, and the wind direction based on the same environmental information is outside the headwind determination angle α in FIG. 20 and outside the tailwind determination angle β in the same figure. In other words, the crosswind state Wc may be assumed to be a state in which the following device 1s receives wind with at least the lateral direction La component outside the headwind determination angle α and outside the tailwind determination angle β. As a result, in the crosswind condition Wc in which the lateral direction La component of the wind resistance Rrw, which is smaller than the air resistance Rra, increases, the vertical formation Po is selected as the platoon formation, and the arrangement direction of each device 1h, 1s is optimized to the vertical direction Lo.

With respect to the following device 1s, in the case where the air resistance Rra is smaller than the wind resistance Rrw acting in the crosswind state Wc, the optimization block 160 optimizes the platoon formation to the parallel formation Pa shown in FIG. 19 in S103. Here, the crosswind condition Wc may be defined in the same manner as described above. As a result, in the crosswind condition Wc in which the lateral direction La component of the wind resistance Rrw, which is larger than the air resistance Rra, increases, the parallel formation Pa is selected as the platoon formation, and the arrangement direction of each device 1h, 1s is optimized to the lateral direction La. In this case, particularly, the platoon formation may be optimized to the parallel formation Pa in which representative points (for example, center points, etc.) in the vertical direction Lo of each of the leading device 1h and the following device 1s are arranged, as shown in FIG. 19, in this order along the lateral direction La component of the wind direction based on the environmental information acquired by S100. Furthermore, the representative points in the vertical direction Lo of each of the leading device 1h and the following device 1s may be optimized to the parallel formation Pa in which they are arranged in this reverse order along the lateral direction La component of the wind direction.

When the air resistance Rra is substantially equal to the wind resistance Rrw in the crosswind state Wc, the platoon formation may be optimized to the vertical formation Po similar to that shown in FIG. 18. The platoon formation when the air resistance Rra is substantially equal to the wind resistance Rrw in the crosswind condition Wc may be optimized to the parallel formation Pa similar to that shown in FIG. 19.

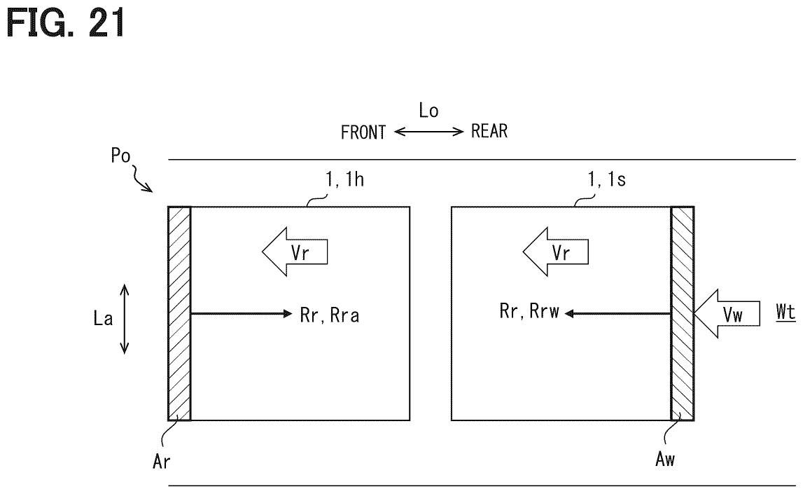

However, even in the cases of FIGS. 17 and 19, when the width in the lateral direction La of the traveling road on which each device 1h, 1s travels is narrower than the width in the lateral direction La required for the parallel formation Pa, the optimization block 160 in S103 limits the optimization of the platoon formation to the parallel form Pa. In this case, as the platoon formation, the vertical formation Po as shown in FIG. 21 may be selected. As shown in FIG. 22, by canceling the platooning itself, the solo traveling formation Ps may be selected in which a distance in the vertical direction Lo is greater than or equal to a set distance between the devices 1h and 1s. FIGS. 21 and 22 show an example corresponding to the case of FIG. 17.

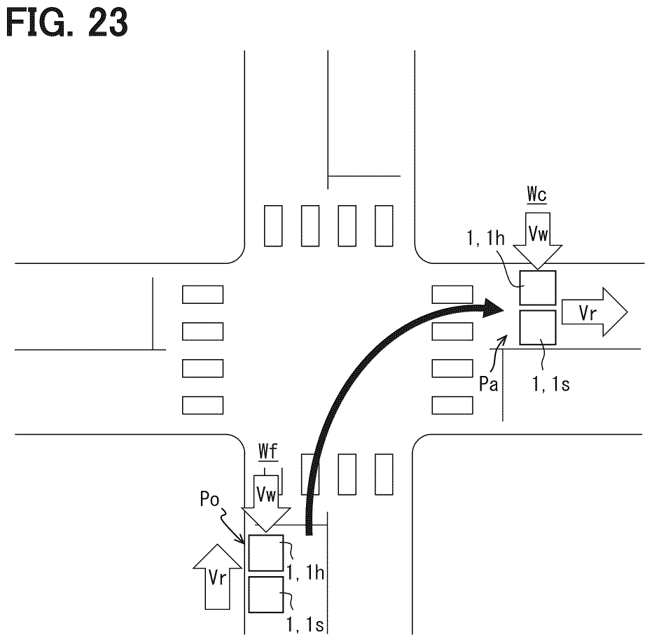

From another perspective, in the case of FIGS. 17 and 19 where the width of the traveling road in the lateral direction La exceeds the necessary width for the parallel formation Pa, it can be said that optimization to the parallel formation Pa is implemented. Further, in cases of FIGS. 14 to 16 and 18, the distance in the vertical direction Lo between the devices 1h and 1s is reduced to be less than the above set distance, and optimization to the vertical formation Po is achieved. Furthermore, for example, when the devices 1h, 1s in the vertical configuration Po turn right (in the example in the same figure) or left in the headwind condition Wf as shown in FIG. 23, the parallel formation Pa (in the example in the same figure) or the lateral configuration Po is implemented depending on the magnitude relationship between the air resistance Rra and the wind resistance Rrw in the crosswind state Wc.

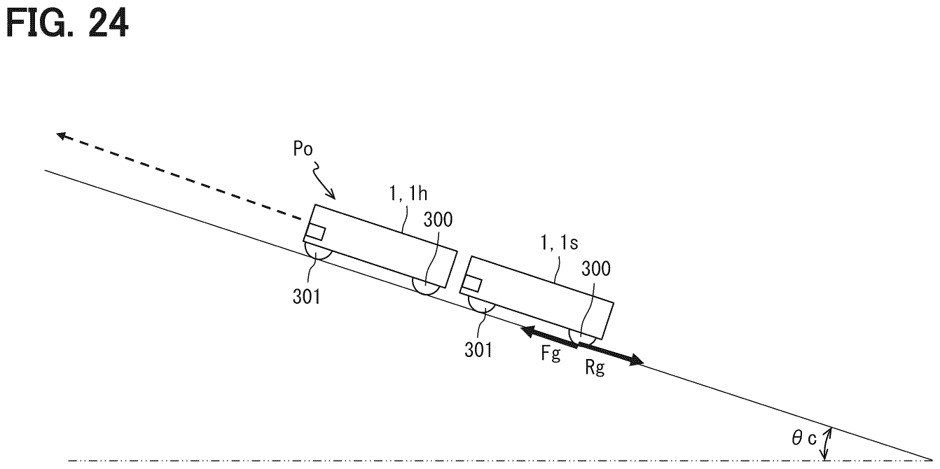

As shown in FIG. 9, in S104 after S103, the optimization block 160 determines whether there is an uphill section as the uphill road that is a traveling road on which each device 1h, 1s is going to travel in the future, based on the road information included in the route information acquired in S100. At this time, when there is the uphill section in which the gradient angle of the road exceeds an uphill limit angle θc as shown in FIG. 24, a positive determination is made, whereas a negative determination is made otherwise.

Here, whether the climbing limit angle θc has been exceeded is determined based on the gradient resistance Rg of at least one of the devices 1h, 1s, the resistance changing in future travel on the uphill road. Therefore, for at least one of the devices 1h, 1s, a traveling section in which the gradient resistance Rg is greater than the grip force Fg of the drive wheels 300 on the uphill road is determined to be the uphill section in which the climbing limit angle θc is exceeded, and a positive determination is made in S104.

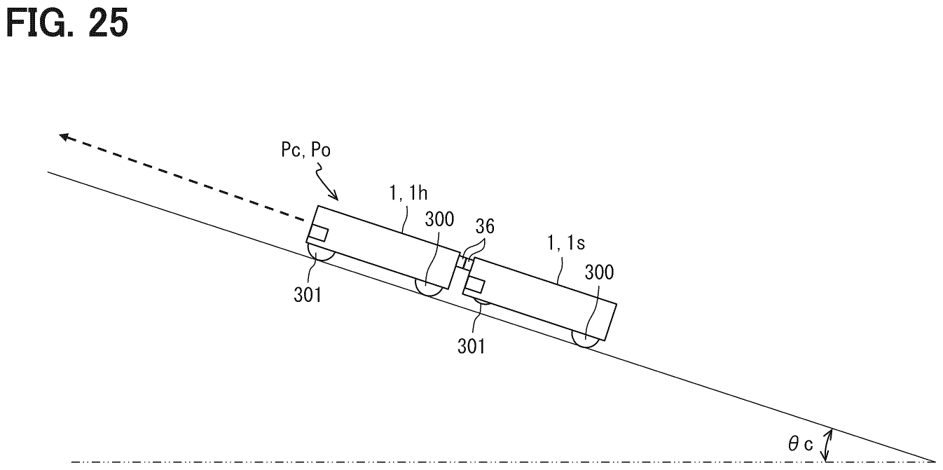

As shown in FIG. 9, when the positive determination is made in S104, the navigation flow proceeds to S105. In S105, the optimization block 160 optimizes the platoon formation in the uphill section to the mutually connected formation Pc in which the driven wheels 301 are separated from the uphill road as shown in FIG. 25. In this mutually connected formation Pc, the platoon formation optimized in S103 (FIG. 25 is an example of a vertical formation Po) is maintained for the traveling point or traveling section corresponding to the uphill section exceeding the climbing limit angle θc.

Therefore, the mutually connected formation configuration Pc at this time is selected as the platoon formation in which the devices 1h, 1s are mutually connected on the uphill road exceeding the climbing limit angle θc by one of the coupling units 36, 37 that corresponds to the optimized configuration in S103. At the same time, the mutually connected formation Pc is also selected as a platoon formation in which multiple wheels among all the driven wheels 301 of the devices 1h, 1s, which correspond to the optimized formation in S103, are maintained in the air by being separated from the uphill road with more than the climbing limit angle θc by the corresponding adjustment units 38.

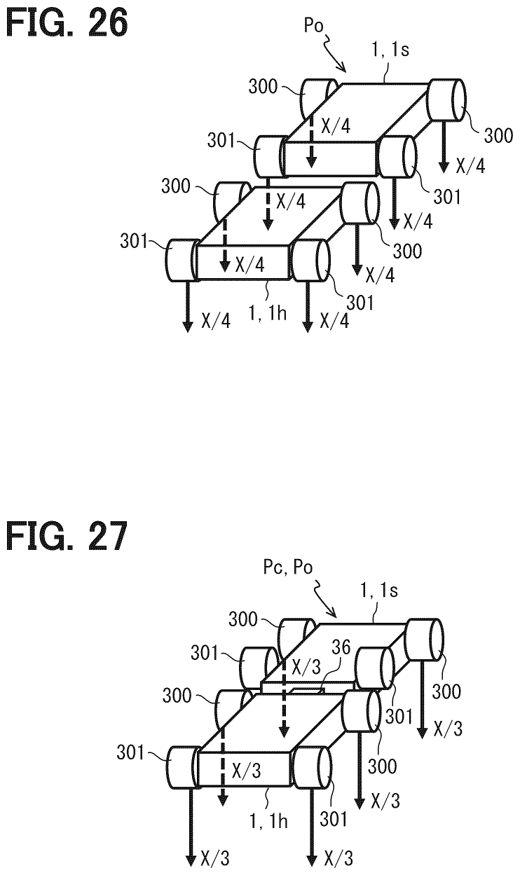

Here, in the mutually connected formation Pc in which the vertical formation Po is maintained on the uphill road, the objects, which are the separation target from the uphill road, are limited to the driven wheels 301 on both sides of the following device 1s, as shown in FIGS. 24 to 27. As a result, for each device 1h, 1s of weight X, in the vertical formation Po immediately before the mutually connected formation Pc as shown in FIG. 26, the load acting from each drive wheel 300 on the uphill road is X/4. On the other hand, in the mutually connected formation Pc in which the vertical formation Po is maintained as shown in FIG. 27, the load acting is X/3. Thereby, in the mutually connected formation Pc which transitions from the immediately preceding disconnected configuration while remaining in the vertical formation Po as the vehicle enters the uphill road exceeding the climbing limit angle θc, the grip force Fg of each drive wheel 300 is increased compared to the immediately preceding force. This also means that the increase in the climbing limit angle θc improves the climbing performance.

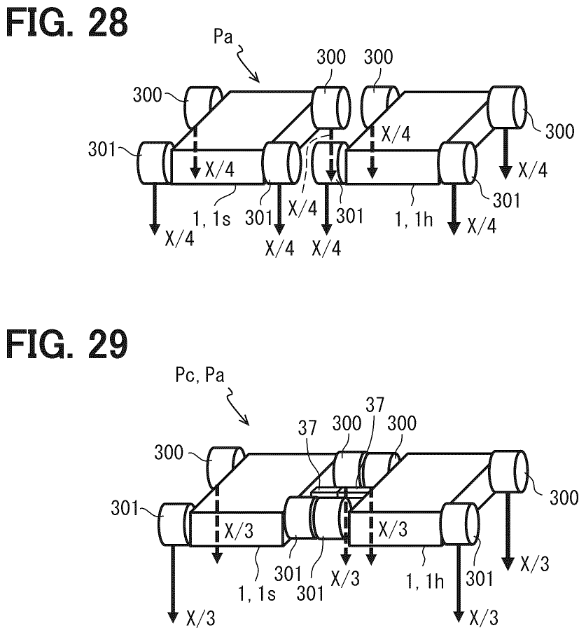

On the other hand, in the mutually connected formation Pc which maintains the parallel formation Pa with respect to the uphill road, as shown in FIGS. 28 and 29, the object to be separated from the uphill road is limited to the one-side driven wheel 301 of the following device 1s closer to the leading device 1h, and the one-side driven wheel 301 of the leading device 1h closer to the following device 1s. However, from the different viewpoint, the object to be separated from the uphill road at this time is selected as the driven wheels 301 of both devices 1h and 1s. As a result, for devices 1h, 1s with weight X, in the parallel formation Pa immediately before the mutually connected formation Pc as shown in FIG. 28, the load acting on each drive wheel 300 is X/4. On the other hand, in the mutually connected formation Pc in which the parallel formation Pa is maintained as shown in FIG. 29, the load acting on each drive wheel 300 is X/3. As a result, in the mutually connected formation Pc, which transitions from the immediately preceding disconnected configuration while remaining in the parallel formation Pa as the vehicle enters the uphill road exceeding the climbing limit angle θc, the grip force Fg of each drive wheel 300 is increased compared to the immediately preceding state. This also means that the increase in the climbing limit angle θc improves the climbing performance.

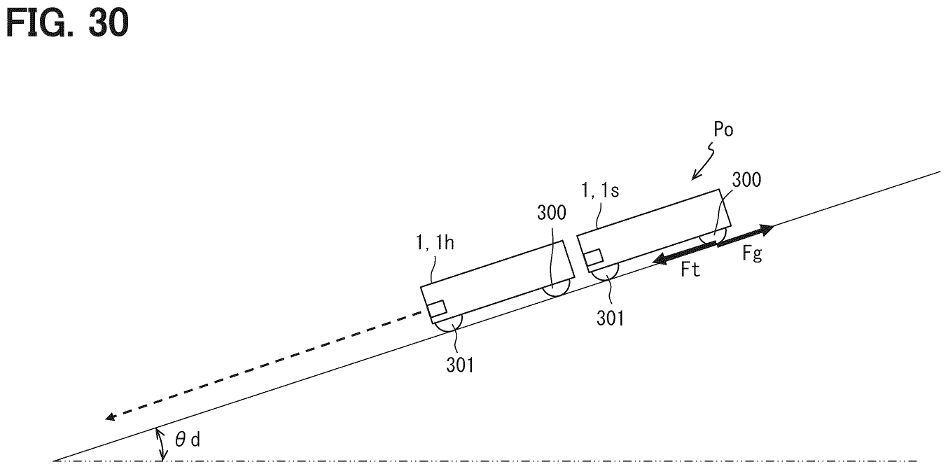

As shown in FIG. 9, when S105 ends, the navigation flow proceeds to S106. When a negative determination is made in S104, the control flow proceeds to S106. In S106, the optimization block 160 determines whether there is a downhill section as the traveling section that is the downhill road on which each of the devices 1h and 1s is going to travel in the future, based on the road information included in the route information acquired in S100. At this time, when there is the downhill section in which the gradient angle of the road exceeds a downhill limit angle θd as shown in FIG. 30, a positive determination is made, whereas a negative determination is made otherwise.

Here, whether the downhill limit angle θd has been exceeded is determined based on a propulsive force Ft of at least one of the devices 1h, 1s that change due to the action of gravity during future travel on a downhill road. Therefore, for at least one of the devices 1h, 1s, a traveling section in which the propulsive force Ft is greater than the grip force Fg of the drive wheels 300 on the downhill road is determined to be a downhill section in which the downhill limit angle θd is exceeded, and a positive determination is made in S106.

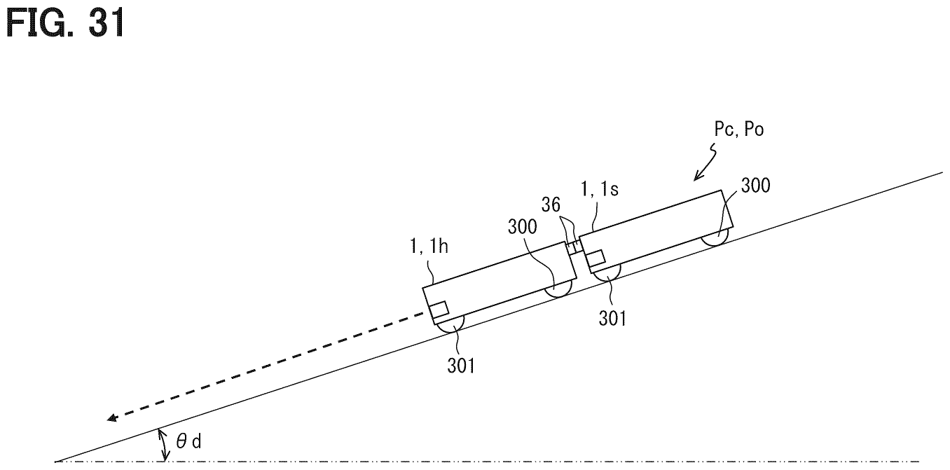

As shown in FIG. 9, when the positive determination is made in S106, the navigation flow proceeds to S107. In S107, the optimization block 160 optimizes the platoon formation in the downhill section to the mutually connected formation Pc in which the driven wheels 301 are separated from the downhill road as shown in FIG. 31. In this mutually connected formation Pc, the platoon formation optimized in S103 (FIG. 31 shows an example of the vertical formation Po) is maintained for the traveling point or traveling section corresponding to the downhill section exceeding the downhill limit angle θd.

Therefore, the mutually connected formation Pc at this time is selected as a platoon formation in which the devices 1h, 1s are mutually connected on the downhill road exceeding the downhill limit angle θd by one of the coupling units 36, 37 that corresponds to the optimized formation in S103. At the same time, the mutually connected formation Pc is also selected as a platoon formation in which multiple wheels among all the driven wheels 301 of the devices 1h and 1s correspond to the optimized formation in S103 and are maintained in the air and separated from the downhill road that exceeds the downhill limit angle θd, by the corresponding adjustment units 38.

Here, in the mutually connected formation Pc in which the vertical formation Po is maintained on the downhill road, the objects, which are the separation target from the downhill road, are limited to the driven wheels 301 on both sides of the following device 1s, as shown in FIGS. 31, 26, and 27. On the other hand, in the mutually connected formation Pc which maintains the parallel formation Pa with respect to the downhill road, as shown in FIGS. 28 and 29, the object to be separated from the downhill road is limited to the one-side driven wheel 301 of the following device 1s closer to the leading device 1h, and the one-side driven wheel 301 of the leading device 1h closer to the following device 1s. However, from the different viewpoint, the object to be separated from the downhill road at this time is selected as the driven wheels 301 of both devices 1h and 1s. In addition, for any mutually connected formation Pc that maintains any of the formations Po and Pa, when the vehicle is on the downhill road in S107, the grip force Fg of each drive wheel 300 increases from immediately before due to the same principle as when the vehicle is on the uphill road in S105.

As shown in FIG. 9, in S108 following S107, the optimization block 160 estimates the regenerative power generated by regenerative braking in the downhill section where the downhill limit angle θd is exceeded in the electric actuator 34 of each device 1h, 1s, based on the actuator information among the device information acquired in S101.

In S109, which is executed in parallel with S108 or before or after (example of FIG. 9), the optimization block 160 selects one of the devices 1h, 1s with the largest free charge capacity (available or chargeable capacity) in the battery 32 as a recovery device 1c, as illustrated in FIGS. 32 and 33. At this time, the free capacity of the battery 32 of each of the devices 1h and 1s is estimated for the downhill section based on the battery information in the device information acquired in S101 and the path information in the route information acquired in S100.

As shown in FIG. 9, in S110, which is performed after S108 and S109, the optimization block 160 determines whether the free capacity of the battery 32 of the recovery device 1c is insufficient for the total regenerative power generated in each device 1h, 1s. As a result, when a negative determination is made, that is, when the total amount of regenerative power generated in each of the devices 1h, 1s exceeds the available capacity of the battery 32 of the recovery device 1c, the navigation flow proceeds to S111.

In S111, the optimization block 160 updates the selection of the mutually connected formation Pc optimized in S107 to the mutually connected formation Pc that recovers the regenerative power generated in each of the devices 1h and 1s to the battery 32 of the recovery device 1c as shown in FIGS. 32 and 33.

As shown in FIG. 9, when S111 ends, the navigation flow proceeds to S112. When a negative determination is made in S106, the control flow proceeds to S112. Furthermore, when a positive determination is made in S110, the navigation flow also proceeds to S112. In S112, the navigation block 170 navigates each of the devices 1h, 1s to a platoon formation selected for each traveling point or traveling section by the executed process among S103, S105, S107, and S111, in accordance with the path information in the route information acquired in S100. At this time, the navigation block 170 may monitor the navigation state of each of the devices 1h and 1s based on the device information of each of the devices 1h and 1s acquired in accordance with S101. When S110 ends, the current execution of the navigation flow also ends.

### Operation and Effects

The operation effects of the first embodiment described above will be described below.

According to the first embodiment, the platoon formation, including the mutually connected formation Pc, is optimized based on the changing gradient resistance Rg of at least one of the autonomous traveling devices 1 in future traveling on the uphill road. According to this, each autonomous traveling device 1 can be navigated by providing a platoon formation that can reduce power consumption from the perspective of gradient resistance Rg, which affects the total electric energy. Therefore, it is possible to reduce the total consumption of electric energy.

In the first embodiment, in each autonomous traveling device 1, the wheel 30 that is driven by power supply from the battery 32 and the wheel 30 that is driven by the wheel 30 are defined as the drive wheel 300 and the driven wheel 301, respectively. Therefore, according to the first embodiment, the platoon formation is optimized to the mutually connected formation Pc in which the driven wheels 301 of at least one autonomous traveling device 1 are separated from the uphill road. According to this, in at least one autonomous traveling device 1, the mutually connected formation Pc in which the driven wheel 301 is separated from the traveling road can increase the grip force Fg of the drive wheel 300 in each autonomous traveling device 1. Thereby, it is possible to reduce the power consumption. Therefore, it is possible to appropriately reduce the total consumption of electric energy.

According to the first embodiment, when the gradient resistance Rg is greater than the grip force Fg on the uphill road in at least one autonomous traveling device 1, the platoon formation is optimized to the mutually connected formation Pc in which the driven wheels 301 of at least one autonomous traveling device 1 are separated from the uphill road. According to this, in a scene in which the power consumption of each autonomous traveling device 1 increases due to gradient resistance Rg that is greater than grip force Fg, the driven wheels 301 of at least one of the devices 1 can be separated from the road. Therefore, in each autonomous traveling device 1, the grip force Fg of the drive wheels 300 can be increased to reduce the power consumption. Therefore, it is possible to increase the accuracy of reducing the total electric energy consumption.

According to the first embodiment, the propulsion force Ft changes due to gravity during future traveling on a downhill road. When the propulsion force Ft is greater than the grip force Fg of the drive wheel 300 on the downhill road, the platoon formation is optimized to the mutually connected formation Pc in which the driven wheel 301 of at least one autonomous traveling device 1 is separated from the downhill road. According to this, regardless of the state of the brake unit 340 that brakes each autonomous traveling device 1 on the downhill road, it is possible to ensure the deceleration function of the autonomous traveling devices 1 according to the difference between the grip force Fg that can be increased by the drive wheel 300 and the propulsive force Ft.

According to the first embodiment, the platoon formation is optimized to the mutually connected formation Pc in which the regenerative power generated in each autonomous traveling device 1 on the downhill road is collected by the battery 32 of one of the devices 1. According to this, in a scene in which regenerative power may be generated in each autonomous traveling device 1, one of the batteries 32 can be shared by the mutually connected formation Pc. Therefore, it is possible to efficiently collect the regenerative power. Therefore, on a downhill road, the total amount of electric energy consumption can be supplemented by regeneration. It is possible to reduce the apparent total amount of electric energy consumption.

According to the first embodiment, the arrangement direction of each autonomous traveling device 1 in the mutually connected formation Pc is optimized based on the air resistance Rra, which depends on the traveling speed Vr generated in the autonomous traveling device 1, and the wind resistance Rrw, which depends on the wind speed Vw acting on the autonomous traveling device 1. According to this, the arrangement direction for enabling the reduction of electric energy consumption is given to the mutually connected formation Pc in which the driven wheels 301 of at least one autonomous traveling device 1 are separated from the traveling road, in consideration of the air resistance Rra and wind resistance Rrw, which affect the total electrical energy. Thereby, each autonomous traveling device 1 can be navigated. Therefore, it is possible to appropriately reduce the total consumption of electric energy.

In the first embodiment, in the arrangement direction in the vertical direction Lo, the autonomous traveling device 1 traveling at the front and the autonomous traveling device 1 traveling following it are defined as the leading device 1h and the following device 1s, respectively. Therefore, according to the first embodiment, when the air resistance Rra acts on the following device 1s in the windless state Wn, the arrangement direction of each device 1h, 1s in the mutually connected formation Pc is optimized in the vertical direction Lo. According to this, in the windless state Wn in which the total electric energy is limited and dependent on air resistance Rra, the mutually connected formation Pc in which each device 1h, 1s is arranged in the vertical direction Lo can reduce the air resistance Rra on the following device 1s as much as possible. Thereby, it is possible to reduce power consumption. Therefore, it is possible to improve the accuracy of reducing the total consumption of electric energy.

According to the first embodiment, when the air resistance Rra acts on the following device 1s in the headwind state Wf, the arrangement direction of each device 1h, 1s in the mutually connected formation Pc is optimized in the vertical direction Lo. According to this, in the headwind state Wf in which the total electric energy is affected by both air resistance Rra and wind resistance Rrw, the mutually connected formation Pc in which each device 1h, 1s is arranged in the vertical direction Lo can reduce both of the resistances Rra, Rrw on the following device 1s as much as possible. Thereby, it is possible to reduce the electric energy consumption. Therefore, it is possible to improve the accuracy of reducing the total consumption of electric energy.

According to the first embodiment, when the air resistance Rra for the following device 1s is greater than the wind resistance Rrw (absolute value) in the tailwind state Wt, the arrangement direction of each device 1h, 1s in the mutually connected formation Pc is optimized in the vertical direction Lo. According to this, in the tailwind state Wt in which the total electric energy is more dependent on air resistance Rra than on wind resistance Rrw, the mutually connected formation Pc in which each device 1h, 1s is arranged in the vertical direction Lo can reduce the air resistance Rra on the following device 1s as much as possible. Thereby, it is possible to reduce the power consumption. Therefore, it is possible to improve the accuracy of reducing the total consumption of electric energy.

According to the first embodiment, when the air resistance Rra for the following device 1s is greater than the wind resistance Rrw in the crosswind state Wc, the arrangement direction of each device 1h, 1s in the mutually connected formation Pc is optimized in the vertical direction Lo. According to this, in the crosswind state Wt in which the total electric energy is more dependent on air resistance Rra than on wind resistance Rrw, the mutually connected formation Pc in which each device 1h, 1s is arranged in the vertical direction Lo can reduce the air resistance Rra on the following device 1s as much as possible. Thereby, it is possible to reduce the power consumption. Therefore, it is possible to improve the accuracy of reducing the total consumption of electric energy.

According to the first embodiment, when the air resistance Rra for the following device 1s is smaller than the wind resistance Rrw (absolute value) in the tailwind state Wt, the arrangement direction of each device 1h, 1s in the mutually connected formation Pc is optimized to the lateral direction La. According to this, in the tailwind state Wt in which the total electric energy is more influenced by wind resistance Rrw than by air resistance Rra, the mutually connected formation Pc in which each device 1h, 1s is arranged in the lateral direction La can reversely utilize the wind resistance Rrw on the following device 1s as propulsion force. Thereby, it is possible to reduce the power consumption. Therefore, it is possible to improve the accuracy of reducing the total consumption of electric energy.

According to the first embodiment, when the air resistance Rra for the following device 1s is smaller than the wind resistance Rrw in the crosswind state Wc, the arrangement direction of each device 1h, 1s in the mutually connected formation Pc is optimized in the lateral direction La. According to this, in the crosswind condition Wc in which the total electric energy is more affected by wind resistance Rrw than by air resistance Rra, the mutually connected formation Pc in which each device 1h, 1s is arranged in the lateral direction La can reduce the wind resistance Rrw on the following device 1s as much as possible. Thereby, it is possible to reduce the power consumption. Therefore, it is possible to improve the accuracy of reducing the total consumption of electric energy.

### Second Embodiment

A second embodiment is a modification of the first embodiment.

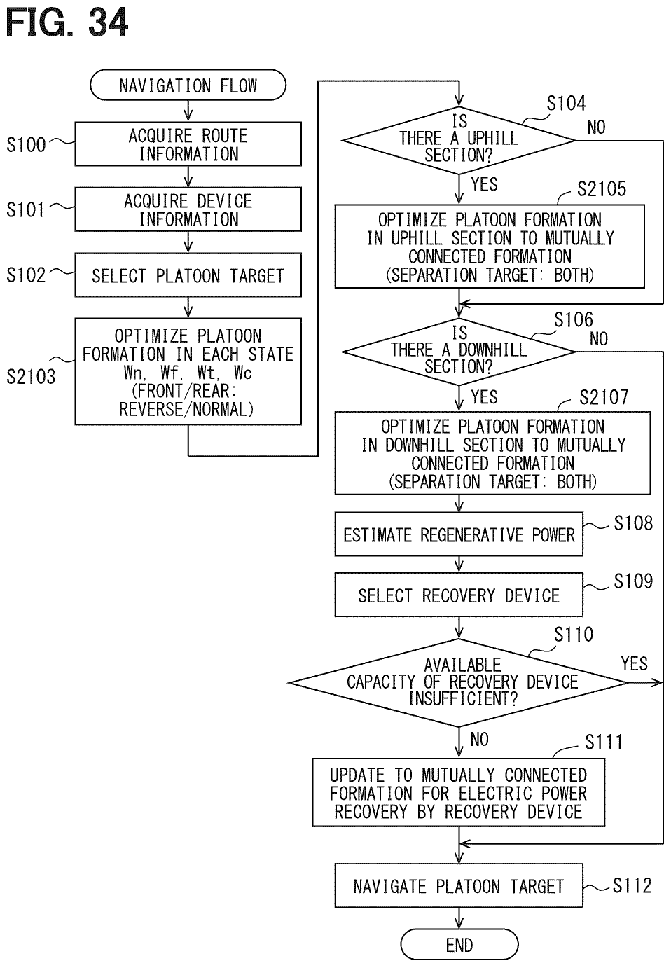

In the navigation flow of the second embodiment, as shown in FIG. 34, S2103 instead of S103 of the first embodiment, S2105 instead of S105 of the first embodiment, and S2107 instead of S107 of the first embodiment are executed.

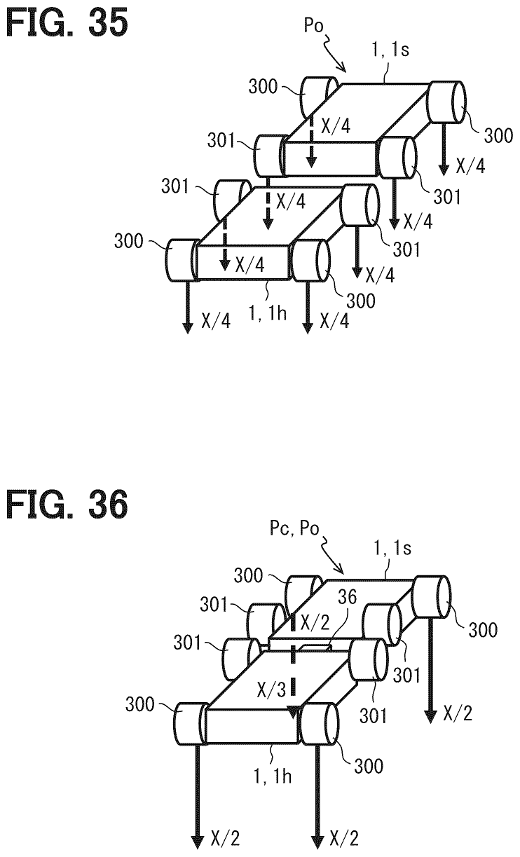

Specifically, in S2103, the optimization block 160 switches the front-rear relationship of the traveling direction along the vertical direction Lo of the traveling road of the leading device 1h in the vertical formation Po to a reverse relationship opposite to that in the parallel formation Pa and the single traveling configuration Ps. As a result, in the vertical formation Po as shown in FIG. 35, in the leading device 1h in a reverse relationship in which the front and rear of the body 2 are interchanged, the left and right driven wheels 301 are located behind each drive wheel 300, respectively. S2103 other than the processed described above are executed in the same manner as S103 in the first embodiment. That is, in the parallel formation Pa and the solo traveling formation Ps, the left and right driven wheels 301 are positioned in front of each drive wheel 300 in a leading device 1h having a normal relationship similar to that of the first embodiment.

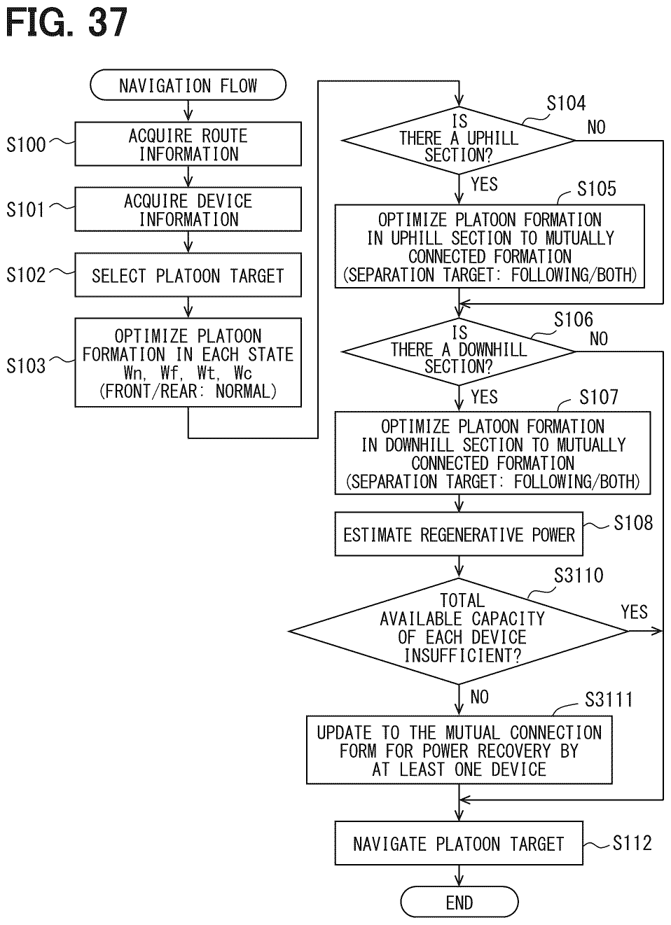

In S2105, the optimization block 160 optimizes the mutually connected formation Pc that maintains the vertical formation Po on the uphill road as shown in FIG. 36, to a platoon formation in which the target for separation from the uphill road includes both side driven wheels 301 of each of the devices 1h and 1s. As a result, for each device 1h, 1s of weight X, in the vertical formation Po immediately before the mutually connected formation Pc as shown in FIG. 35, the load acting from each drive wheel 300 on the uphill road is X/4. On the other hand, in the mutually connected formation Pc in which the vertical formation Po is maintained as shown in FIG. 36, the load acting is X/2. Thereby, in the mutually connected formation Pc which transitions from the immediately preceding disconnected configuration while remaining in the lateral Po as the vehicle enters the uphill road exceeding the climbing limit angle θc, the grip force Fg of each drive wheel 300 is increased compared to the immediately force that. This also means that the increase in the climbing limit angle θc improves the climbing performance.

Similarly, in S2107, the optimization block 160 optimizes the mutually connected formation Pc that maintains the vertical formation Po on the downhill road as shown in FIG. 36, to a platoon formation in which the target for separation from the downhill road includes both side driven wheels 301 of each of the devices 1h and 1s. S2105 and S2107 are executed in the same manner as S105 and S107 in the first embodiment, respectively, except for the points described above. That is, in the mutually connected formation Pc in which the parallel formation Pa is maintained, the targets for separation from the uphill road and the downhill road are also selected as the driven wheels 301 on both sides of each of the devices 1h, 1s.

According to the second embodiment described above, the platoon formation is optimized to the mutually connected formation Pc in which the driven wheels 301 of both autonomous traveling devices 1 are separated from the uphill road. According to this, in both autonomous traveling devices 1, the mutually connected formation Pc in which the driven wheel 301 is separated from the traveling road can increase the grip force Fg of the drive wheel 300 in each autonomous traveling device 1. Thereby, it is possible to reduce the power consumption. Therefore, it is possible to appropriately reduce the total consumption of electric energy.

According to the second embodiment, when the gradient resistance Rg is greater than the grip force Fg on the uphill road in at least one autonomous traveling device 1, the platoon formation is optimized to the mutually connected formation Pc in which the driven wheels 301 of both autonomous traveling devices 1 are separated from the uphill road. According to this, in a scene in which the power consumption of each autonomous traveling device 1 increases due to gradient resistance Rg that is greater than grip force Fg, the driven wheels 301 of both devices 1 can be separated from the road. Therefore, in each autonomous traveling device 1, the grip force Fg of the drive wheels 300 can be increased to reduce the power consumption. Therefore, it is possible to increase the accuracy of reducing the total electric energy consumption.

According to the second embodiment, the propulsion force Ft changes due to gravity during future traveling on a downhill road. When the propulsion force Ft is greater than the grip force Fg of the drive wheel 300 on the downhill road, the platoon formation is optimized to the mutually connected formation Pc in which the driven wheel 301 of both autonomous traveling devices 1 is separated from the downhill road. According to this, regardless of the state of the brake unit 340 that brakes each autonomous traveling device 1 on the downhill road, it is possible to ensure the deceleration function of the autonomous traveling devices 1 according to the difference between the grip force Fg that can be increased by the drive wheel 300 and the propulsive force Ft.

### Third Embodiment

A third embodiment is another modification of the first embodiment.

In the navigation flow of the third embodiment, as shown in FIG. 37, S3110 instead of S109 and S110 of the first embodiment, and S3111 instead of S111 of the first embodiment are executed. Specifically, in S3110, the optimization block 160 determines whether the total free capacity of the batteries 32 of each of the autonomous traveling devices 1h, 1s that are the platooning targets is insufficient for the total regenerative power generated by each of the autonomous traveling devices 1h, 1s. At this time, the free capacity of the battery 32 of each of the devices 1h and 1s is estimated for the downhill section based on the battery information in the device information acquired in S101 and the path information in the route information acquired in S100.

When a negative determination is made as a result of S3110, that is, when the total of the regenerative power generated in each of the devices 1h, 1s exceeds the total free capacity of each of the batteries 32 of the devices 1h, 1s, the navigation flow proceeds to S3111. In S3111, the optimization block 160 updates the selection for the mutually connected formation Pc optimized in S107 to the mutually connected formation Pc in which at least one of the batteries 32 of each device 1h, 1s with the free capacity collects the regenerative power generated in each device 1h, 1s.

When S3111 ends in this manner, the navigation flow proceeds to S112. Also, when a positive determination is made in S3110, the navigation flow proceeds to S112. Furthermore, similarly to the first embodiment, when a negative determination is made in S106, the navigation flow also proceeds to S112. However, in S112 of the third embodiment, each of the devices 1h and 1s is navigated to a platoon formation selected for each travel point or travel section by the route process among S103, S105, S107, and S3111.

According to the third embodiment described above, the platoon formation is optimized to the mutually connected formation Pc in which the regenerative power generated in each autonomous traveling device 1 on the downhill road is collected by the battery 32 of at least one of those devices 1. According to this, in a scene in which regenerative power may be generated in each autonomous traveling device 1, at least one of the batteries 32 can be shared by the mutually connected formation Pc. Therefore, it is possible to efficiently collect the regenerative power. Therefore, on a downhill road, the total amount of electric energy consumption can be supplemented by regeneration. It is possible to reduce the apparent total amount of electric energy consumption.

### Other Embodiment

Although multiple embodiments have been described above, the present disclosure is not construed as being limited to those embodiments, and can be applied to various embodiments and combinations within a scope that does not depart from the spirit of the present disclosure.

In a modification, the dedicated computer constituting the control system 8 of the navigation system 10 and/or the processing device 120 of the autonomous traveling device 1 may have at least one of a digital circuit or an analog circuit as a processor. The digital circuit is at least one type of, for example, an application specific integrated circuit (i.e., ASIC), a field programmable gate array (i.e., FPGA), a system on a chip (i.e., SOC), a programmable gate array (i.e., PGA), a complex programmable logic device (i.e., CPLD), and the like. Such a digital circuit may also include a memory in which a program is stored.

In the modification, the lateral coupling unit 37 may not be provided. In S105, S107, S2105, and S2107 of this modification, the parallel formation Pa immediately before becoming the mutually connected formation Pc may be switched to the vertical formation Po to implement the mutually connected formation Pc.

In the modification, the lateral coupling unit 36 may not be provided. In S105, S107, S2105, and S2107 of this modification, the mutually connected formation Pc may be switched from the vertical formation Po immediately before becoming the mutually connected formation Pc to the parallel formation Pa, and the mutually connected formation Pc may be implemented.

In the modification, in the windless state Wn, the parallel formation Pa may be selected. In the windless state Wn of the modification, the solo traveling formation Ps of each of the devices 1h and 1s may be selected. In the modification, the headwind state Wf, the parallel formation Pa may be selected. In the modification, the headwind state Wf, the solo traveling formation Ps of each of the devices 1h and 1s may be selected.

In the modification, in the tailwind state Wt, optimization of the platoon formation may be limited to the vertical formation Po, regardless of the magnitude relationship between the wind resistance Rrw and the air resistance Rra. In the modification, in the tailwind state Wt, optimization of the platoon formation may be limited to the parallel formation Pa, regardless of the magnitude relationship between the wind resistance Rrw and the air resistance Rra. In the modification, in the tailwind state Wt, the solo traveling formation Ps of each of the devices 1h, 1s may be selected instead of at least one of the vertical formation Po or the parallel formation Pa according to the magnitude relationship between the wind resistance Rrw and the air resistance Rra.

In the modification, in the crosswind state Wc, the optimization of the platoon formation may be limited to the vertical formation Po, regardless of the magnitude relationship between the wind resistance Rrw and the air resistance Rra. In the modification, in the crosswind state Wc, the optimization of the platoon formation may be limited to the parallel formation Pa, regardless of the magnitude relationship between the wind resistance Rrw and the air resistance Rra. In the modification, in the crosswind state Wc, the solo traveling formation Ps of each of the devices 1h, 1s may be selected instead of at least one of the vertical formation Po or the parallel formation Pa according to the magnitude relationship between the wind resistance Rrw and the air resistance Rra.

In the modification, the platoon formation of three or more autonomous traveling devices 1 may be optimized. The autonomous traveling device 1 of the modification may be, for example, a two-wheel drive type or a four-wheel drive type capable of turning in response to steering, other than a two-wheel drive type capable of turning in response to a difference in rotational speed. Additionally, this variation may include at least one driven wheel 301.

In S104 of the modification, a positive determination may be made when the gradient resistance Rg is greater than the grip force Fg in both of the devices 1h and 1s, whereas a negative determination may be made in other cases. In S106 of the modification, a positive determination may be made when the propulsive force Ft is greater than the grip force Fg in both of the devices 1h and 1s, whereas a negative determination may be made in other cases.

In the modification, the second embodiment may be combined with the third embodiment. In addition to the above description, the above-described embodiments and modification may be implemented in the form of a processing circuit (for example, a processing ECU, and the like) or a semiconductor circuit (for example, a semiconductor chip, and the like) as a navigation system that is configured to be mounted on the autonomous traveling device 1 and replaces the functions of the processing device 120 with the control system 8.

What is claimed is:

1. A navigation system for navigating a plurality of autonomous traveling devices that autonomously travel using power supplied from a battery, the system comprising:
a processor configured to:
optimize a platoon formation based on a gradient resistance that occurs on at least one of the plurality of autonomous traveling devices that are caused to travel in the platoon formation including a mutually connected formation and changes in future traveling on an uphill road; and
navigate each autonomous traveling device to the optimized platoon formation.

2. The navigation system according to claim 1, wherein
in the plurality of autonomous traveling devices, a wheel driven by the power supplied from the battery is defined as a drive wheel,
in the plurality of autonomous traveling devices, a wheel following the drive wheel is defined as a driven wheel,
optimization of the platoon formation includes: optimization of the platoon formation to the mutually connected formation in which the driven wheel is separated from the uphill road.

3. The navigation system according to claim 2, wherein
the optimization of the platoon formation includes optimization of the platoon formation to the mutually connected formation in which the driven wheel is separated from the uphill road when the gradient resistance is greater than a grip force of the drive wheel on the uphill road.

4. The navigation system according to claim 3, wherein
the optimization of the platoon formation includes optimization of the platoon formation to the mutually connected formation in which the driven wheel is separated from a downhill road when a propulsive force that changes due to gravity in future traveling on the downhill road that enables braking by a brake unit of the autonomous traveling device is greater than the grip force of the drive wheel on the downhill road.

5. The navigation system according to claim 4, wherein
the optimization of the platoon formation includes optimization of the platoon formation to the mutually connected formation that causes the battery of at least one of the plurality of autonomous traveling devices to collect regenerative power generated in each autonomous traveling device on the downhill road.

6. The navigation system according to claim 1, wherein
optimization of the platoon formation includes optimization of an arrangement direction of the plurality of autonomous traveling devices in the mutually connected formation based on air resistance depending on a travel speed generated on the plurality of autonomous traveling devices and a wind resistance depending on a wind speed acting on the plurality of autonomous traveling devices.

7. The navigation system according to claim 6, wherein
in the arrangement direction that is a vertical direction, among the plurality of autonomous traveling devices, an autonomous traveling device that follows an autonomous traveling device that performs lead traveling is defined as a following device, and
the optimization of the platoon formation includes optimization of the arrangement direction in the mutually connected formation to the vertical direction in at least one of a case where the air resistance acts on the following device in a headwind state or a case where the air resistance acts on the following device in a windless state.

8. The navigation system according to claim 7, wherein
the optimization of the platoon formation includes optimization of the arrangement direction in the mutually connected formation to the vertical direction in at least one of a case where the air resistance for the following device is greater than the wind resistance in a crosswind state or a case where the air resistance for the following device is greater than the wind resistance in a tailwind state.

9. The navigation system according to claim 7, wherein
the optimization of the platoon formation includes optimization of the arrangement direction in the mutually connected formation to a lateral direction in at least one of a case where the air resistance for the following device is smaller than the wind resistance in a crosswind state or a case where the air resistance for the following device is smaller than the wind resistance in a tailwind state.

10. A navigation method executed by a processor for navigating a plurality of autonomous traveling devices that autonomously travel using power supplied from a battery, the method comprising:
optimizing a platoon formation based on a gradient resistance that occurs on at least one of the plurality of autonomous traveling devices that are caused to travel in the platoon formation including a mutually connected formation and changes in future traveling on an uphill road; and
navigating each autonomous traveling device to the optimized platoon formation.

11. A non-transitory computer-readable storage medium storing a navigation program including instructions executed by a processor for navigating a plurality of autonomous traveling devices that autonomously travel using power supplied from a battery, the processor being configured to:
optimize a platoon formation based on a gradient resistance that occurs on at least one of the plurality of autonomous traveling devices that are caused to travel in the platoon formation including a mutually connected formation and changes in future traveling on an uphill road; and
navigate each autonomous traveling device to the optimized platoon formation.
